(19) United States
(12) Patent Application Publication
(10) Pub. No.: US 2025/0297533 A1
(43) Pub. Date: Sep. 25, 2025

(54) AI-ENHANCED WELL INTERVENTION EQUIPMENT SELECTION SYSTEM

(71) Applicant: SAUDI ARABIAN OIL COMPANY, Dhahran (SA)

(72) Inventors: Bander A. Khonain, Dammam (SA); James O. Arukhe, Dhahran (SA); Abdulrahman M. Zahrani, Dhahran (SA)

(73) Assignee: SAUDI ARABIAN OIL COMPANY, Dhahran (SA)

(21) Appl. No.: 18/611,279

(22) Filed: Mar. 20, 2024

(51) Int. Cl. E21B 43/30; E21B 43/12

(52) U.S. Cl. CPC E21B 41/00; E21B 2200/20; E21B 2200/22; G06N 20/00

(57) ABSTRACT

A method for determining and performing an optimum well intervention sequence on a well operation described by an operating condition. The method includes obtaining a first well data for the well operation and determining, using an artificial intelligence (AI) model with the first well data as input, a first operating condition for the well operation. The method further includes obtaining a plurality of well interventions that can be performed on the well operation, determining, using a reinforcement learning (RL) policy, an optimum well intervention sequence that optimizes a performance of the well operation and performing the optimum well intervention sequence on the well operation.

### BACKGROUND

Drilling, operating, and maintaining a hydrocarbon well require a variety of interventions. Interventions range from repairing or customizing mechanical components of the well to altering the geological formations around the well.

The selection of a well intervention may influence a well operation. For example, while performing a suitable well intervention may result in improving the well operation, selecting an improper well intervention may result in a disruption of the well operation and an opportunity loss.

Well interventions are typically resource intensive. Selecting a well intervention is also resource intensive as it may require extensive analysis, expensive simulations, and decision making in view of uncertainties. By capturing well data, artificial intelligence may potentially offer assistance in the well intervention selection process in order to optimize the well operation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for determining and performing an optimum well intervention sequence on a well operation described by an operating condition. The method includes obtaining a first well data for the well operation and determining, using an artificial intelligence (AI) model with the first well data as input, a first operating condition for the well operation. The method further includes obtaining a plurality of well interventions that can be performed on the well operation, determining, using a reinforcement learning (RL) policy, an optimum well intervention sequence that optimizes a performance of the well operation and performing the optimum well intervention sequence on the well operation.

In one aspect, embodiments disclosed herein relate to a system configured to determine and send a command to perform an optimum well intervention sequence on a well operation described by an operating condition. The system includes a well on which the well operation is performed, a plurality of sensors connected to the well, equipment to perform a plurality of well interventions on the well operation, a simulator configured to simulate the well interventions within the plurality of well interventions, a computer that includes one or more computer processors and a command system. The computer is configured to receive from, at least, the sensors, a first well data for the well operation and determine, using an artificial intelligence (AI) model with the first well data as input, a first operating condition for the well operation. The computer is further configured to determine, using a reinforcement learning (RL) policy, an optimum well intervention sequence that optimizes a performance of the well operation. The command system is configured to send a command to perform the optimum well intervention sequence on the well operation.

In one aspect, embodiments disclosed herein relate to a non-transitory computer-readable memory configured to determine and send a command to perform an optimum well intervention sequence on a well operation described by an operating condition. The non-transitory computer-readable memory includes computer-executable instructions stored thereon that, when executed on a processor, cause the processor to perform steps including obtaining a first well data for the well operation and determining, using an artificial intelligence (AI) model with the first well data as input, a first operating condition for the well operation. The steps further include obtaining a plurality of well interventions that can be performed on the well operation, determining, using a reinforcement learning (RL) policy, an optimum well intervention sequence that optimizes a performance of the well operation and sending a command to perform the optimum well intervention sequence on the well operation.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example hydrocarbon production well site, in accordance with one or more embodiments disclosed herein.

FIG. 2 depicts a well drilling site, in accordance with one or more embodiments disclosed herein.

FIG. 3 depicts a system for determining an operating condition, in accordance with one or more embodiments disclosed herein.

FIG. 4 depicts a system for determining an optimum well intervention, in accordance with one or more embodiments disclosed herein.

FIG. 5 depicts a system for recommending an optimum well intervention sequence, in accordance with one or more embodiments disclosed herein.

FIG. 6 depicts a system for determining an experience sample, in accordance with one or more embodiments disclosed herein.

FIG. 7 depicts a forward model and a training example, in accordance with one or more embodiments disclosed herein.

FIG. 8 depicts a deep Q-leaning model, in accordance with one or more embodiments disclosed herein.

FIG. 9 depicts a method for obtaining an optimum well intervention sequence, in accordance with one or more embodiments disclosed herein.

FIG. 10 depicts an example diagram of a neural network, in accordance with one or more embodiments disclosed herein.

FIG. 11 depicts an example diagram of a computer, in accordance with one or more embodiments disclosed herein.

FIG. 12A depicts a bar plot, in accordance with one or more embodiments disclosed herein.

FIG. 12B depicts a bar plot, in accordance with one or more embodiments disclosed herein.

FIG. 12C depicts a bar plot, in accordance with one or more embodiments disclosed herein.

FIG. 13 depicts an example implementation, accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

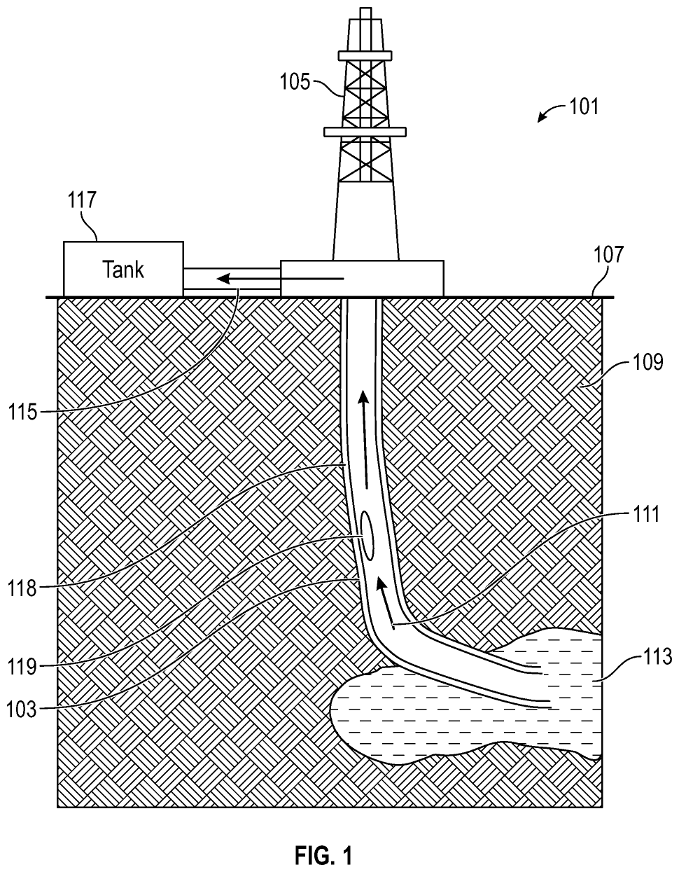

In the following description of FIGS. 1-13, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

One or more embodiments disclosed herein relate to methods and systems that make use of artificial intelligence to select an optimum well intervention sequence intended to optimize a well operation. The system revolutionizes intervention strategies by accurately analyzing a range of input variables such as tubing specifications, targeted zone depth, formation characteristics, and crude oil properties. Based on this analysis, the system outputs highly tailored recommendations for intervention equipment and securement methods. This AI-driven approach employs a blend of Convolutional Neural Networks (CNN) and Reinforcement Learning (RL) to not only streamline the decision-making process but also significantly improve the efficiency and safety of well intervention operations.

The scope of this disclosure extends to, at least, several types of well operations. Two example well operations are described herein: a hydrocarbon production operation and a drilling operation. These well operations may be given with greater specificity or may be described as categories of well operations. For example, operations such as a well completion operation and a well plugging operation may be categorized as drilling operations. Those skilled in the art will readily appreciate that the methods and systems described in this disclosure may further apply to other types of well operations.

FIG. 1 depicts a well (101) where hydrocarbons are extracted from a hydrocarbon reservoir (113) located in the subsurface (109). Rocks of the hydrocarbon reservoir (113) are called reservoir rocks. The direction of a flow (111) is from the hydrocarbon reservoir (113) to a surface (107). In general, a hydrocarbon production well may be configured in a myriad of ways. Therefore, the well (101) is not intended to be limiting to any particular configuration. The well (101) is depicted as being on land. In other examples, the well (101) may be located offshore. In some instances, the hydrocarbons are extracted using a derrick (105) located on the surface (107). A pipeline (115) connects the derrick (105) to a tank (117), in which the hydrocarbons are collected. A casing (118), disposed in the well (101) against the wellbore (103), is typically formed of a durable material such as steel. The casing (118) isolates the hydrocarbons and supports the wellbore (103).

A plurality of sensors (119), connected to the wellbore (103), is set up to measure well data at one or more locations in the wellbore (103). Examples of well data that may be measured by the sensors include a hydrocarbon production rate, a density of the hydrocarbons, a velocity of the hydrocarbons through the wellbore (103), and a pressure and a temperature at the sensor's (105) locations. Examples of sensors that may be included among the plurality of sensors (119) include a pressure sensor, a flow rate sensor, a temperature sensor, a gas detector, and an acoustic sensor. In FIG. 1, the sensors (119) are grouped together and located downhole on the side of the wellbore (103). However, this example should not be considered limiting and in other embodiments the sensors (119) may be separated and located anywhere, downhole or at the surface, connected to the wellbore (103). Generally, the extracted hydrocarbons are not pure. Fluids extracted from the reservoir, called production fluids, include hydrocarbons and water. In one or more embodiments, the production fluids form a tri-phase fluid composed of water, oil and gas and the plurality of sensors (119) include a multiphase flow meter (MPFM). In general, an MPFM is a collection of sensors, transmitters, mechanical devices, flow conduits, and programmed relationships that are used to determine the flow rates for each individual phase of the hydrocarbons. A MPFM may further include a gamma densitometer to measure a density of the hydrocarbons. A gamma densitometer emits a beam of photons from a nuclear source. Then, the emitted photons are attenuated by the multiphase fluid and the amount of attenuation is determined using a nuclear detector that measures the number of received photons. An MPFM may further include a Venturi section that is used to measure mass flow rates.

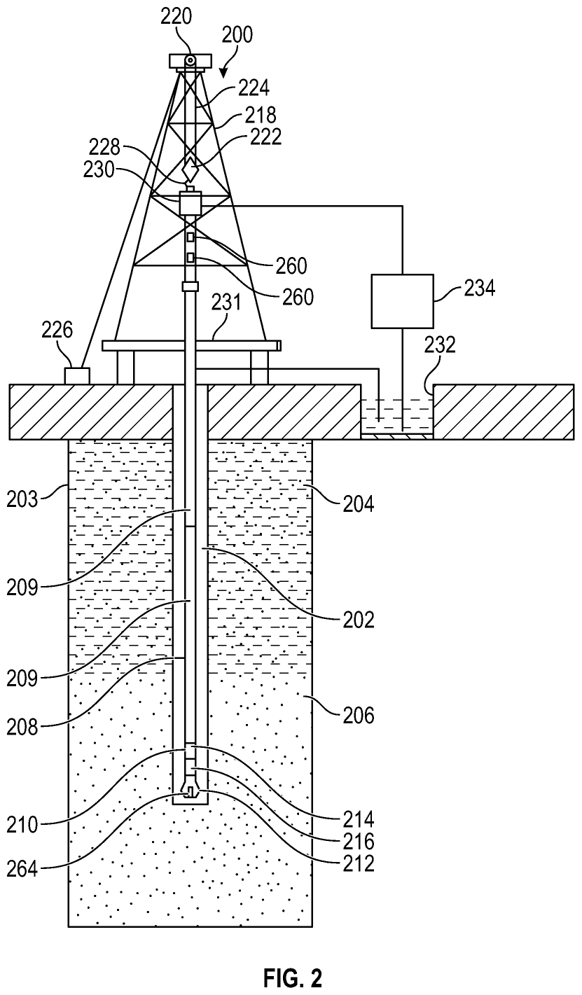

FIG. 2 illustrates an exemplary well site (200) where a drilling operation is conducted. The well site (200) is not intended to be limiting with respect to the particular configuration. The well site (200) is depicted as being on land. In other examples, the well site (200) may be offshore, and drilling may be carried out with or without use of a marine riser. A drilling operation at well site (200) may include drilling a wellbore (202) into a subsurface (203) to reach a hydrocarbon reservoir. Generally, the subsurface (203) may include various geological formations. In the example of FIG. 2, a first geological formation (204) and a second geological formation (206) are depicted. Each geological formation may be composed of various rocks.

For the purpose of drilling, a drill string (208) is suspended within the wellbore (202). The drill string (208) may include one or more drill pipes (209) connected to form conduit and a bottom hole assembly (BHA) (210) is disposed at the distal end of the conduit. The BHA (210) may include a drill bit (212) to cut into the subsurface rock. In one or more embodiments, the BHA (210) may include measurement tools, such as a measurement-while-drilling (MWD) tool (214) and logging-while-drilling (LWD) tool (216). Measurement tools (214, 216) may include sensors and hardware to measure downhole drilling parameters, and these measurements may be transmitted to the surface using any suitable telemetry system known in the art. The BHA (210) and the drill string (208) may include other drilling tools known in the art but not specifically shown. The drill string (208) may be suspended in the wellbore (202) by a derrick (218). A crown block (220) may be mounted at the top of the derrick (218), and a traveling block (222) may hang down from the crown block (220) by means of a cable or drilling line (224). One end of the cable or drilling line (224) may be connected to a drawworks (226). The drawworks (226) is a reeling device that can be used to adjust the length of the cable or drilling line (224) so that the traveling block (222) may move up or down the derrick (218). The traveling block (222) may include a hook (228) on which a top drive (230) is supported.

During a drilling operation at the well site (200), the drill string (208) is rotated relative to the wellbore (202), and weight is applied to the drill bit (212) to enable the drill bit (212) to break rock as the drill string (208) is rotated. In one or more embodiments, the drill string (208) is rotated by operating the top drive (230), which is coupled to the top of the drill string (208). Alternatively, the drill string (208) may be rotated by means of a rotary table (not shown) on the drilling floor (231), or independently with a downhole drilling motor. In some embodiments, the drill bit (212) may be rotated using a combination of the drilling motor and the top drive (230) (or a rotary swivel if a rotary table is used instead of a top drive to rotate the drill string (208)). Drilling fluid (commonly called mud) may be stored in a mud pit (232), and at least one mud pump (234) may pump the mud from the mud pit (232) into the drill string (208). The mud may flow into the drill string (208) through appropriate flow paths in the top drive (230) (or a rotary swivel if a rotary table is used instead of a top drive to rotate the drill string (208) and exit into the bottom of the wellbore (202) through nozzles in the drill bit (212). The mud in the wellbore (202) then flows back up to the surface in an annular space between the drill string (208) and the wellbore (202) with entrained cuttings. The mud with the cuttings is returned to the mud pit (232) to be circulated back again into the drill string (208). Typically, the cuttings are removed from the mud, and the mud is reconditioned as necessary, before pumping the mud again into the drill string (208).

Generally, a drilling operation, such as the one depicted in FIG. 2, is controlled by a set of drilling parameters. Examples of drilling parameters controlling a drilling operation include, but are not limited to, a weight on bit (WOB), a drill string rotational speed (RPM), a torque of the drill bit, a mud flow rate (e.g., in the units of gallons per minute (GPM)), a drilling direction, and properties of the mud, such as a viscosity or a hydraulic pressure of the mud injection.

In one or more embodiments, one or more sensors (260) are connected to the well site (200). As a non-limiting example, sensors (260) may be arranged to measure one or more drilling parameters, such as the mud-flow rate or the ROP. For illustration purposes, sensors (260) are shown on drill string (208) and proximate mud pump (234). The illustrated locations of sensors (260) are not intended to be limiting, and sensors (260) could be disposed wherever drilling parameters need to be measured. Moreover, there may be many more sensors (260) than shown in FIG. 2 to measure various other parameters of the drilling operation. Each sensor (260) may be configured to measure a desired physical stimulus. One or more sensor systems (264) according to embodiments disclosed herein may be fitted into nozzle receptacles in the drill bit (212). The sensor systems (264) may collect downhole data in addition to or alternatively to data collected by sensors (260). In some embodiments, sensor systems (264) may be used to collect downhole data that other sensors (260) would otherwise not be able to collect, e.g., downhole data related to conditions at the drill bit (212), such as temperature at the bit, bit vibration, and drilling fluid exit flow rate.

Generally, a subsurface, such as the subsurface (203) and the subsurface (109), is attributed a set of subsurface properties, that may highly depend on a geographical location of well operation. The subsurface properties may further vary with depth within the subsurface. Examples of subsurface properties that may be attributed to the subsurface include, but are not limited to a density, a porosity, a permeability or a mineral composition of the rocks composing the subsurface. Another, notable example of a subsurface property is an unconfined compressive strength of the rocks within the subsurface.

Embodiments of this disclosure connect four key elements, namely: a well intervention, an operating condition, a performance of the well operation, and well data. During a course of a well operation, one or more well interventions may be performed. Well interventions serve a variety of purposes. For instance, during the course of a well operation, a well intervention may be needed to repair or replace a piece of equipment, secure a wellbore, facilitate a fluid flow, or inject material into surrounding geological formations. Each well intervention makes use of specific equipment. Two different well interventions may serve two completely different purposes, however, often the overall goal of well interventions is to optimize the well operation. Example well interventions are described herein. It is emphasized that the well interventions described herein are given only as examples and should be considered non-limiting. One with ordinary skill in the art will recognize that other well interventions may be included without departing from the scope of this disclosure.

Examples of well interventions include hydraulic fracturing, designed to extract hydrocarbons from an underground rock. Hydraulic fracturing includes injecting a fracturing fluid at a high-pressure, from the surface into the wellbore, to create fractures in a reservoir rock. The fracturing fluid includes a liquid phase and a permeable proppant. Examples of a liquid phase of the fracturing fluid include water. Examples of material that may be used as a permeable proppant include sand. In some embodiments, the fracturing fluid further includes a chemical additive. In one or more embodiments, the pressure of the fracturing fluid is considered as high if it is greater than a predefined high-pressure threshold. A portion of the permeable proppant stays in the fractures. As such, the permeable proppant increases the permeability of the reservoir rock by holding the factures open while letting hydrocarbons flow into the wellbore. A residual fluid, that includes a portion of the liquid phase and a remaining portion of the proppant, flows back to the surface. At the surface, the residual fluid is re-conditioned as fracturing fluid to be re-injected into the wellbore. Examples of equipment that may be used in a hydraulic fracturing operation include a high-pressure pump that pumps the fracturing fluid into the wellbore. Examples of equipment that may be used in a hydraulic fracturing operation further include a wellhead and a tree assembly (sometimes referred to as a Christmas tree assembly), that control the fracturing fluid flow from the surface. Examples of equipment that may be used in a hydraulic fracturing operation further include downhole tools, such as a perforating gun and a logging instrument, configured to access the wellbore and acquire well data. Examples of equipment that may be used in a hydraulic fracturing operation further include equipment to re-condition the residual fluid, such as a tank or a fluid-sand separator.

Examples of well interventions further include frackpacking. Frackpacking is a portmanteau term combining fracturing and packing. Frackpacking involves combining hydraulic fracturing with gravel packing. Gravel packing involves placing a screen or slotted liner in the wellbore, and then pumping a deformable material, such as gravel or sand, into the annular space between the screen and the reservoir formation. The deformable material creates a permeable barrier that prevents the proppant using during hydraulic fracturing from entering the wellbore. Examples of equipment that may be used for frackpacking include any equipment used in hydraulic fracturing. Examples of equipment that may be used for frackpacking further include equipment for gravel packing, such as a gravel packer, a screen, and a slotted liner.

Examples of well interventions further include acidizing. Acidizing is another technique to enhance the permeability of a reservoir rock by improving the flow of hydrocarbons to the wellbore. Acidizing involves injecting acid into the reservoir rock surrounding the wellbore to dissolve minerals within the reservoir rock and open channels in the formation. The channels then provide a path for the hydrocarbons to migrate from the reservoir rock into the wellbore. Examples of reservoir rocks that may be dissolved by acid include, but are not limited to, limestone, dolomite, and sand. In some embodiments, acidizing is performed in conjunction with hydraulic fracturing, by adding acid to the fracturing fluid. Examples of acids that may be used for acidizing include hydrochloric acid (HCl), hydrofluoric acid (HF), and a combination thereof. Examples of equipment that may be used for acidizing include a high-pressure pump to deliver the acid into the wellbore, an acid storage tank, a blender, and coil tubing.

Well intervention examples further include cleaning the wellbore and removing debris from the wellbore. Examples of equipment that may be used for cleaning or removing debris from the wellbore include coil tubing.

Another well intervention example is cementing. Cementing involves placing cement slurry into an annular space between the casing and the wellbore. In some embodiments, cementing provides structural support to the wellbore and prevents the wellbore from collapsing. In some embodiments, cementing provides a zonal isolation that prevents a migration of production fluids between different geological formations, or between the drilling fluids and the geological formations. Cement squeezing is a specific type of cementing. Cement squeezing includes injecting cement into the wellbore at a high pressure to seal off unwanted fluid pathways and remediate leaks in the wellbore. Cement squeezing may further be used to block water-producing zones in a geological formation, improving a volume fraction of hydrocarbons in the production fluids. Examples of equipment that may be used for cementing include a cementing head that controls the flow of cement slurry into the wellbore, a centralizer that controls a distribution of the cement in the wellbore, and a blender to prepare the cement slurry.

Examples of well interventions further include water flooding. Water flooding is a recovery method designed to increase a production of hydrocarbons of a first well. Water flooding includes injecting water into a second well, called an injection well, located in a vicinity of the first well. The injected water increases a pressure in the underground rock. The increased pressure displaces and drives additional hydrocarbons toward the first well, increasing the production of the first well. The water injected into the second well may come from an external source, such as a river or a lake. In some embodiments, the water injected into the second well comes from a water portion of the production fluids. Examples of equipment that may be used for water flooding include a high-pressure, pivotal, water injection pump that delivers water into the second well. Examples of equipment that may be used for water flooding further include a wellhead assembly that controls the injection of water and a downhole flow control device that optimizes a water distribution within the reservoir. In some embodiments, a reservoir simulation software may be used to determine parameters of the water injection.

Examples of well interventions further include perforation. Perforation involves creating holes in the well casing and surrounding cement to allow hydrocarbons to flow into the wellbore from a reservoir rock. Examples of equipment that may be used for perforation include a perforating gun, such as a tubing conveyed perforating gun. A tubing conveyed perforating gun is conveyed downhole on tubing strings, where it perforates the well structure using a shaped explosive charge. The shape of the charge determines a penetration pattern. Multiple perforating guns may be arranged as a perforating gun string that carves perforations at different depths within the wellbore.

Examples of well interventions further include a wireline service. A wireline service involves lowering a cable into the wellbore to perform tasks such as data acquisition, well logging, retrieving downhole equipment, perforating the well casing, or conducting a maintenance operation. Examples of equipment that may be used for a wireline service include a wireline unit. A wireline unit may include wireline logging tools that measure pieces of well data, such as reservoir properties and a production fluid content. A wireline unit may further include a tubing conveyed perforating tool configured to perform a perforation action. A wireline unit may further include pressure control equipment such as a blowout preventer and a grease injection device. Examples of equipment that may be used for a wireline service further include a fishing tool, attached to the wireline unit, configured to help retrieve equipment that is lost inside the wellbore. Examples of equipment that may be used for a wireline service include a wireline sheave and a jar that guide and control a wireline movement in the wellbore.

Examples of well interventions further include a hydraulic workover. A hydraulic workover is defined as any well intervention that utilizes hydraulic power without using a conventional drilling rig. Interventions that may be performed as a hydraulic workover include pulling and running tubing, cleaning the wellbore, or perforation. Examples of equipment that may be used for a hydraulic workover include a hydraulic workover unit. A hydraulic workover unit is a mobile or skid-mounted rig equipped with hydraulic systems. Examples of equipment that may be used for a hydraulic workover further include a hydraulic snubbing unit configured to run or pull tubulars in and out of the wellbore. Examples of equipment that may be used for a hydraulic workover further include a hydraulic power swivel configured to rotate tubulars, a hydraulic blowout preventer configured to prevent an uncontrolled fluid release, a hydraulic casing jack configured to lift and support casing strings during a repair, and a hydraulic choke configured to regulate a fluid flow.

Examples of well interventions further include an artificial lift. Artificial lift enhances the flow of hydrocarbons through the wellbore from the reservoir to the surface. Artificial lifting may be performed in many ways, such as rod pumping, electrical submersible pumping, hydraulic pumping, plunger lifting, or gas-lifting. Rod pumping utilizes a pumping unit, placed at the surface, that drives a downhole rod string. The downhole rod string lifts production fluids to the surface. Electrical submersible pumping involves placing an electric submersible pump downhole to boost a production fluid flow towards the surface. Hydraulic pumping involves pumping the production fluids to the surface using a hydraulic piston pump. Plunger lifting involves periodically lifting the production fluids to the surface using a plunger. Fluid jetting involves sending high-pressure fluid jets to increase the downhole pressure, resulting in lifting the production fluids to the surface. Gas-lifting involves injecting gas from the surface into the production fluids disposed downhole, thereby lowering the density and hydrostatic pressure of the production fluids. This allows the in-situ reservoir pressure to lift the production fluids. Examples of equipment that may be used for artificial lifting include coil tubing. Examples of equipment that may be used for gas-lifting include a pump that pumps the gas into an annulus of the well, valves that control an injection of gas into the well, and a compressor that boosts the pressure of the injected gas.

Examples of well interventions further include bullheading. Bullheading involves pumping a bullheading fluid into the wellbore to push existing fluids, such as drilling mud, debris, or blockages, downhole. In some embodiments, bullheading is used to clean the wellbore. Examples of equipment that may be used for bullheading include a high-pressure pump that pumps the bullheading fluid and a high-pressure line through which the bullheading fluid may flow at a high pressure. Examples of equipment that may be used for bullheading further include a bullheading manifold. A bull heading manifold includes valves and one or more pipes that control the flow of the bullheading fluid.

Examples of well interventions further include snubbing. Snubbing involves inserting tools and tubulars into the wellbore to perform a well intervention without halting a the well operation. Examples of equipment that may be used for snubbing include a hydraulic or mechanical snubbing unit that controls a descent or ascent of a pipe or tubing within the wellbore. Examples of equipment that may be used for snubbing further include a blowout preventer, such as an annular-type preventer and a ram-type preventer. Examples of equipment that may be used for snubbing further include a snubbing elevator configured to support tools during snubbing.

As stated, some well interventions, such as well cleaning, acidizing and artificial lift, may make use of coil tubing. In that regard, examples of well interventions further include a coil tubing insertion. Generally, coil tubing serves as a conduit for fluid flow and equipment for a well intervention. For instance, an electric submersible pump or a perforating gun may be installed within the coil tubing. Examples of equipment that may be used to support coil tubing include a tubing anchor that prevents an axial movement of the coil tubing. Examples of equipment that may be used to support coil tubing further include a crossover or a coupling, configured to connect a tubing joint.

In accordance with one or more embodiments, a well intervention is defined by both an action or process and the equipment used to perform the action or process. That is, the use of two distinct pieces of equipment suffice to define two distinct well interventions even when performing the same action or process. For example, acidizing using coil tubing and acidizing using a wireline are considered as two different well interventions. As another example, an artificial lift using an electrical submersible pump and an artificial lift using a hydraulic, non-submersible pump are considered as two different well interventions.

Generally, a well operation is described by a set of one or more descriptors. The set of one or more descriptors that describe the well operation is called an operating condition of the well operation. The operating condition can be defined in many ways. Examples of descriptors of the operating condition include, but are not limited to, a pressure stability status, a temperature normality status, a gas migration status, a production fluid composition, a production fluid stability, a water content of the production fluid, a production fluid flow rate, a rate of penetration of a drill bit. In some embodiments, a pressure stability status is a binary indicator equal to “stable” if the pressure is stable and “unstable” if the pressure is unstable. In some embodiments, the temperature normality status is equal to “normal” if the temperature lies within a certain expected temperature range and “abnormal” otherwise. In some embodiments, the gas migration status is set to “positive” if a gas migration is occurring and “negative” if no gas migration is occurring. In some embodiments, the production fluid stability is equal to “stable” is the production fluid composition is stable and “unstable” if the production fluid composition is changing. A fluid composition may include a volume fraction of oil, gas, water, or any combination thereof in the production fluid. A water content may include a volume fraction of water in the production fluid. In one or more embodiments, the operating condition includes an encoded vector of numbers resulting from artificial intelligence.

Accordingly, in one or more embodiments, a general operating condition type is a set composed of one or more categorical variables, encoding vectors, and numerical variables, or any combination thereof. That is, an operating condition may be a set of one or more categorical variables a set of one or more encoding vectors a set of one or more numerical variables, or any combination thereof. As an example, in some instances the operating condition is a set composed of one or more categorical variables and one or more encoding vectors. In other instances, the operating condition is a set composed of one or more categorical variables and one or more numerical variables. In some implementations, the categorical variables may be converted to numbers. For instance, the pressure stability status can be converted to 1 if the pressure is stable, or 0 otherwise. In such scenarios, the operating condition, including any categorical variables, numerical variables, and encoded vectors can be simply written as a vector of numbers.

A well operation may be assessed through a performance of the well operation. The performance of the well operation depends on the operating condition of the well operation. In one or more embodiments, the performance is a numerical indicator with an ordering relation. In that regard, a first performance of the well operation, assessed at a first time, may be less than, equal, or greater than a second performance assessed at a second time. Examples for a performance for a drilling operation include a rate of penetration (ROP) of a drill bit. In some embodiments, the performance of a drilling operation increases with an increase of the ROP. Examples of a performance for a hydrocarbon production include the production flow rate. In some embodiments, the performance of hydrocarbon production increases with an increase of the production flow rate. Further examples of a performance of the well operation include the revenue of the well operation and the environmental impact of the well operation. An ordered relationship may also exist for a non-numerical performance. Examples for a non-numerical performance for a well operation include a safety indicator, equal to “safe” or “unsafe,” that indicates whether the well operation is operating safely. In some embodiments, a performance of “safe” is classified as better than a performance of “unsafe.” Increasing the performance of the well operation is referred to as optimizing the well operation. Further, the performance of a well operation may be considered as optimum if the performance cannot be improved. The performance of a well operation may be considered as non-optimum if the performance is not optimum. It is noted that in some embodiments, the performance is defined as a component of the operating condition. For instance, in some embodiments, the operating condition includes the ROP of a drill bit and the performance of the well operation is the ROP of the drill bit. In other embodiments, the performance is defined as the operating condition. For instance, in some embodiments, the operating condition is defined as the ROP of a drill bit and the performance of the well operation is also defined as the ROP of the drill bit. In other embodiments, the performance is not defined as a component of the operating condition. For instance, in some embodiments, the operating condition is the pressure stability status and the performance is the ROP of the drill bit.

Three example operating conditions are described herein. The first example is a combination of an encoded vector, a numerical variable, and a categorical variable. The second example is a set of three categorical variables. The third example is an encoded vector. Example performances of the well operation based on these three example operating conditions are also described. The first example operating condition is a set E=(P, V, c), where P is a water content, V is an encoded vector of real numbers and c is a pressure stability status equal to 1 if the pressure is stable, or 0 otherwise. A first example performance associated with the first example operating condition is a production fluid flow rate F. In one or more embodiments, such a performance is considered optimum if F is greater than a pre-defined production threshold. A second example performance associated with the first example operating condition is an inverse of the water content: 1/P. In one or more embodiments, such performance is considered optimum if it is greater than a pre-defined performance threshold, that is, if the water content is less than the inverse of the performance threshold. As a remark in this case, the water content P is both included in the performance and the operating condition. A third example performance associated with the first example operating condition is a combination of the production fluid flow rate F and the water content P: F+1/P. In one or more embodiments, such performance is considered optimum if it is greater than a pre-defined performance threshold. In this case, the performance increases with an increase of the production fluid flow rate and with a decrease of the water content.

The second example operating condition is a set (c₁, c₂, c₃), where c₁ is the pressure stability status, c₂ is a temperature normality status and c₃ is a gas migration status. In such scenarios, the operating condition is a plurality of classes, i.e.: a set of three categorical variables. Similar to the first example operating condition, a first example performance associated with the second example operating condition is the production fluid flow rate F. A second example performance associated with the second example operating condition is the set (c₁, c₂, c₃) itself. In one or more embodiments, the performance is considered optimum if the pressure stability status is “stable,” the temperature normality status is “normal,” and the gas migration status is “negative.” The performance is considered non-optimum otherwise. In some embodiments, the categorical variables (c₁, c₂, c₃) are converted to integers (\tilde{c}₁, \tilde{c}₂, \tilde{c}₃): the pressure stability status \tilde{c}₁ is set to 1 if the pressure is stable, or 0 otherwise. The temperature normality status \tilde{c}₂ is set to 1 if the temperature is normal, or 0 otherwise. The gas migration status \tilde{c}₃ is set to 1 if no gas migration is occurring, or 0 if a gas migration is occurring. In such implementations, a third example performance associated with the second example operating condition is a sum c₁+c₂+c₃. The optimum performance is 3. The third example operating condition is an encoding vector V resulting from artificial intelligence. Examples of such an encoding vector are described in other paragraphs of this disclosure. An example performance for the third example operating condition is a mathematical function that takes V as input and returns the performance as a real number.

It is emphasized that the example operating conditions and example associated performances described in this disclosure are given only as examples and should be considered non-limiting. One with ordinary skill in the art will recognize that other operating conditions and performances may be defined without departing from the scope of this disclosure.

A well intervention, such as the well interventions described in other paragraphs of this disclosure, may modify the operating condition. More precisely, a well intervention may transform a first operating condition into a second operating condition. Therefore, if the performance associated with the second operating condition is greater than the performance associated with the first operating condition, the well intervention may be used to optimize the performance of the well operation. Three example transformations from a first operating condition into a second operating condition by means of a well intervention are provided herein.

In the first example transformation, the operating condition includes the production fluid stability and the well intervention is a cementing intervention. Assuming that a production fluid composition change is detected for the production fluid composition, the production fluid stability set to “unstable.” In one or more embodiments, the production fluid change is due to an inadequate zonal isolation of the well allowing a migration of fluids between different geological formations. In such scenarios, a cementing intervention may be performed to create a barrier between different geological formations, hence preventing an unwanted mixing of the fluids from the different geological formations. After the cementing intervention, the production fluid composition becomes stable. The cementing intervention has transformed a first operating condition, in which the production fluid stability set to “unstable,” into a second operating condition in which the production fluid stability is set to “stable.”

In the second example transformation, the operating condition includes the pressure stability status and the well intervention is a water flooding intervention, a cleaning intervention, or a cementing intervention. Assuming that a pressure fluctuation is detected, the pressure stability status is set to “unstable.” Pressure stability may be a consequence of various factors, such as, for example, a reservoir depletion, a fluid movement within the reservoir, a gas migration an issue with the well integrity. If the pressure fluctuation originates from a reservoir depletion, a water flooding intervention may be performed to the reservoir, restoring the pressure stability. If pressure fluctuation originates from a fluid movement within the reservoir several well interventions may be performed depending on the cause of the fluid movement. In some situations, the fluid movement is due to a blockage between the reservoir and the production well. A cleaning intervention may remove the blockage, thereby restoring pressure stability. If the fluid movement is due to an improper zonal isolation between different geological formations a cementing operation may improve the zonal isolation, thereby restoring pressure stability. If the pressure fluctuation originates from a gas migration or an issue with the well integrity a squeeze cementing intervention may be performed to repair the well, thereby restoring pressure stability. After the pressure has been stabilized, the pressure stability status is set to “stable.” The well intervention has transformed a first operating condition, in which the pressure stability status is set to “unstable,” into a second operating condition in which the pressure stability status is set to “stable.” In some embodiments, a temperature anomaly has a same origin as the origin of the pressure fluctuation and performing a similar well intervention to the ones described herein helps reset the temperature to a normal state.

In the third example transformation, the operating condition includes an encoded vector describing geological formations at a well location and the well intervention is a hydraulic fracturing operation, a frackpacking operation, or a cementing operation. In some embodiments, the encoded vector is based on mechanical properties of the rocks at the well location. A first encoded vector describes a first set of mechanical properties of the rocks. A well intervention such as hydraulic fracturing or frackpacking may transform the first set of mechanical properties into a second set of mechanical properties, described by a second encoded vector. The hydraulic fracturing operation or frackpacking operation transforms a first operating condition that includes the first encoded vector into a second operating condition that includes the second encoded vector. In other embodiments, the encoded vector is based on a pressure condition in the rocks at the well location. A first encoded vector describes a first pressure condition. A cementing operation may transform the first pressure condition into a second pressure condition described by a second encoded vector. The cementing operation transforms a first operating condition that includes the first encoded vector into a second operating condition that includes the second encoded vector.

In some scenarios, a sequence of well interventions may be performed, rather than a single well intervention. In these scenarios, each well intervention within the well intervention sequence transforms, successively, an operating condition into another operating condition. This results in a sequence of operating conditions. Each operating condition within the sequence of operating conditions is associated a distinct performance. In some embodiments, each well intervention within the sequence of well interventions optimizes the performance of the well operation. However, optimizing the performance at each well intervention is not necessary, as long as the whole sequence of well interventions results in optimizing the performance. Thus, in some embodiments, one or more well interventions within the well intervention sequence degrade the performance. However, other well interventions within the well intervention sequence compensate for such degradation. Completing the well intervention sequence eventually optimizes the performance of the well operation. Example well intervention sequences are described in the following.

The first example well intervention sequence includes bullheading followed by inserting coil tubing. The operating condition includes an ROP of a drilling operation and the first operating condition includes a first ROP of the drilling operation. In some embodiments, a cleaning operation or a bullheading operation is performed to remove debris in the wellbore. The bullheading operation transforms the first operating condition into a second operating condition that includes a second ROP. Then, inserting coil tubing helps circulate the drilling fluid and results in a third operating condition. The third operating condition includes a third ROP. In some embodiments, the third ROP is greater than the first ROP. If the performance of the well operation is defined as an increasing function with respect to the ROP, the third operating condition optimizes the performance compared to the first operating condition.

If the performance of the well operation is based on a hydrocarbon production rate several well intervention sequences may be performed to optimize the hydrocarbon production such as well intervention sequences including hydraulic fracturing, acidizing, artificial lifting, water flooding, perforation, and frackpacking. A first well intervention sequence to optimize the hydrocarbon production rate is defined as follows: first, a well tubing or a wireline is inserted into the wellbore as a first well intervention; then, acidizing is performed as a second well intervention, following the first well intervention. A second well intervention sequence to optimize the hydrocarbon production rate is defined as follows: snubbing, followed by acidizing. A third well intervention sequence to optimize the hydrocarbon production rate is defined as follows: inserting coil tubing, followed by acidizing, followed by water flooding. It is emphasized that the examples of transformations from a first operating condition into a second operating condition described in this disclosure are given only as examples and should be considered non-limiting. One with ordinary skill in the art will recognize that other transformations may be used without departing from the scope of this disclosure.

Generally, the decision to perform and select a well intervention, or a sequence of well interventions, is made using a selection criterion. A selection criterion may be of various types. In some embodiments, the selection criterion is derived from experience. A first performance may be known to be not optimum, and a decision is made to perform a well intervention. Then, a well intervention is performed using a trial and error process: a first well intervention is selected from prior experience, as a possible solution to modify the operating condition in a way that optimizes the performance of the well operation. The first well intervention is performed, transforming the first well operating condition into a second operating condition. A performance of the well operation is assessed. If the performance is optimum, no further well intervention is made. If the performance is not optimum, a second well intervention is selected from experience and performed, transforming the second well operating condition into a third operating condition. In some scenarios, the first well intervention and the second well intervention both improve the performance, sequentially. In other scenarios, the first well intervention degrades the performance and the second well intervention includes a restoration from the first well intervention. In further scenarios, the first well intervention degrades the performance but is a necessary step to optimize the performance through the second well intervention. The performance of the well intervention is assessed again after the second well intervention and the trial and error process either stops, or is iterated using a third well intervention.

In one or more embodiments, the well interventions in the trial-and-error process are simulated, rather than performed. The optimum sequence of well intervention is then recommended or performed after it has been selected by the trial-and-error process. Simulating a well intervention can be done by using a simulator. Examples of simulators that can be used to simulate a well intervention include a multi-phase fluid flow model, a heat equation, a rock physical model, a Bernoulli equation, and a chemical formula, or combination thereof. In some embodiments, the simulator makes use of artificial intelligence.

In one or more embodiments, the selection criterion for a well intervention, or sequence of well interventions makes use of a reinforcement learning (RL) policy. The RL policy receives, as input, an operating condition and returns, as output, ratings for well interventions within a set of well interventions. A rating is a score that defines how desirable a given well intervention is in order to optimize the well operation. A well intervention with the best rating, called a first optimum well intervention, is selected and transforms a first operating condition into a second operating condition. In some embodiments, the RL policy is applied to the second operating condition and a second optimum well intervention is selected. Repeating the process leads to a sequence of optimum well interventions to be performed in order to optimize the performance of the well operation. The sequence of well interventions may include a single well intervention or a plurality of well operations. In some embodiments, the RL policy may determine that no well intervention should be performed. The RL policy is determined using a RL model. In some embodiments, the RL model makes use of a trial-and-error process.

In one or more embodiments, the operating condition is derived from well data. Examples of well data include a depth of the well, a density of the hydrocarbons, a tubing specification, a crude oil property, a salinity of underground water, a velocity of the hydrocarbons through the wellbore, a pressure of the rock at the well location, a temperature of the rock at the well location, a temperature at the drill bit, a bit vibration, a drilling fluid exit flow rate, a mud-flow rate, a seismogram, a composition of the rocks at the well location, and a production fluid composition. The well data may be extracted from various sources, such as publications and well logs. The well data may further be acquired by sensors located on the well operation site. Examples of such sensors are given, for example, by the sensors (119) in FIG. 1, the sensors (260) and tools (214), (216) in FIG. 2.

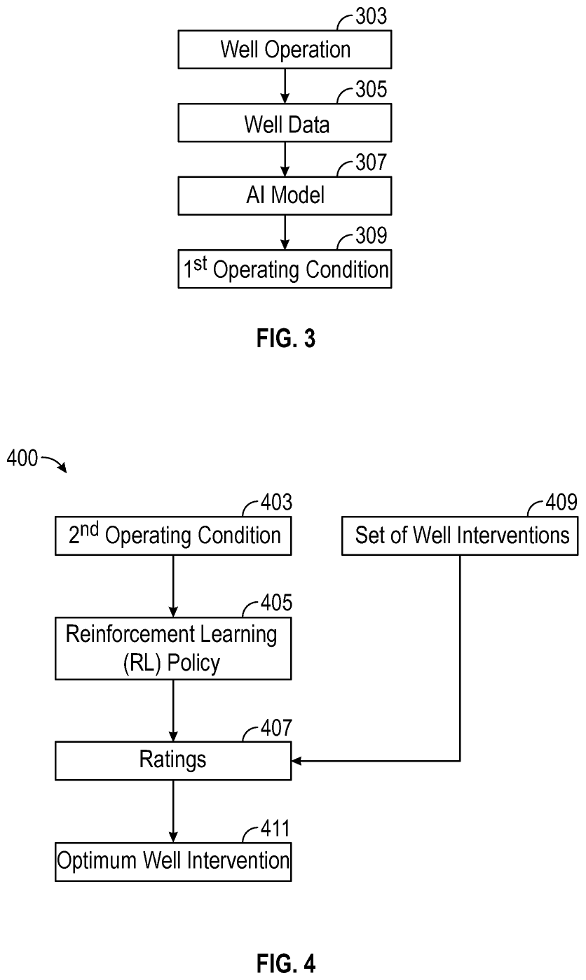

FIG. 3 depicts a system for determining a first operating condition (309) for a well operation (33). Well data (305) including, for example, one or more of the well data described in previous paragraphs of this disclosure, are obtained from the well operation (303). The well data (305) is received as input by an artificial intelligence (AI) model (307) that returns, as output, the first operating condition (309). As stated in other paragraphs of this disclosure, the first operating condition (309) may be of several types and include one or more descriptors. The first operating condition (309) may include one or more indicators, such as a pressure stability status, a temperature normality status and a gas migration status. The first operating condition (309) may include one or more numerical values such as a production fluid composition, a rate of penetration, and a hydrocarbon production rate. The first operating condition (309) may include one or more encoded vectors such as a latent vector derived from artificial intelligence. In one or more embodiments, the first operating condition (309) includes a combination of one or more indicators, numerical values, and encoded vectors. The AI model may include a neural network, such as a fully connected neural network, a convolutional neural network, and a recurrent neural network, in accordance with one or more embodiments.

Depending on the type of the first operating condition (309), the AI model (307) may be configured in several ways. In one or more embodiments, the AI model (307) includes one or more classification models that each return a value, or class, for an indicator. For instance, if the operating condition includes a pressure stability status, a classification model may be trained to classify the pressure stability status into the “stable” category or the “unstable” category. Examples of classification models that may be included in the AI model (307) include a logistic regression model, a support vector machine, and a neural network such as a convolutional neural network (CNN). In one or more embodiments, the AI model (307) includes one or more regression models that each return a numerical value. Examples of regression models that may be included in the AI model (307) include a polynomial fit and a neural network, such as a CNN. In one or more embodiments, the AI model (307) includes an encoder. For instance, if the operating condition includes an encoded vector an encoder may be trained to determine the encoded vector. Examples of encoders that may be included in the AI model include an autoencoder, an embedding model, and any sequence of multiple layers of a neural network. Generally, an encoder includes a neural network, such as a CNN, composed of a plurality of layers including an output layer. The neural network is configured to perform a task and return an output corresponding to the task. The output is a result of the output layer. By contrast, the encoded vector is a result of a layer that is not the output layer. A notable example of an encoder is an auto-encoder. In some examples, an autoencoder includes a plurality of convolutional layers run sequentially. The plurality of convolutional layers can be described as a first set of layers and a second set of layers. The autoencoder is trained to receive an input and return, through the plurality of convolutional layers, an output that is equal to the input. After training, the second set of layers is discarded and an encoding vector, for a given input, is computed as an output of the first set of layers. The AI model (307) may include a combination of one or more classification models, one or more regression models, and one or more encoders. A notable example for the AI model (307) is a CNN composed of one or more components, the CNN performing all the tasks of the AI model (307).

Artificial intelligence models typically involve a training phase and a testing phase, both using previously acquired data. Supervised machine-learned models require examples of input and associated output (i.e., target) pairs in order to learn a desired functional mapping. The AI model (307) may be trained from using known data from existing wells. A dataset of examples may be constructed, each example including an input and an associated output (i.e., target) for a distinct existing well. The input is a set of well data for an existing well. The associated output is an operating condition of the well. In one or more embodiments, the dataset is split into a training dataset and a testing dataset. The example input and associated output pairs of the training dataset are called training examples. The example input and associated output pairs of the testing dataset are called testing examples. It is common practice to split the dataset in a way that the training dataset contains more examples than the testing dataset. Because data splitting is a common practice when training and testing a machine-learned model, it is not described in detail in this disclosure. One with ordinary skill in the art will recognize that any data splitting technique may be applied to the dataset without departing from the scope of this disclosure. The AI model is trained as a functional mapping that optimally matches the inputs of the training examples to the associated outputs of the training examples.

Once trained, the AI model (307) is validated by computing a metric for the testing examples, in accordance with one or more embodiments. If the AI model (307) is a regression model, examples of metrics that may be used to validate the AI model (307) include any scoring or comparison function known in the art, including but not limited to: a mean square error (MSE), a root mean square error (RMSE) and a coefficient of determination (R²), defined respectively as:

$$MSE = \frac{1}{m} {\sum }_{i = 1}^{i = m} {\vert {\hat{y}}_{i} - {y}_{i} \vert}^{2} , \qquad EQ . 1$$

$$RMSE = \sqrt{\frac{1}{m} {\sum }_{i = 1}^{i = m} {\vert {\hat{y}}_{i} - {y}_{i} \vert}^{2}} , \qquad EQ . 2$$

$${R}^{2} = 1 - \frac{{\sum }_{i = 1}^{i = m} {\vert {\hat{y}}_{i} - {y}_{i} \vert}^{2}}{{\sum }_{i = 1}^{i = m} {\vert {y}_{i} - {\overline{y}}_{i} \vert}^{2}} . \qquad EQ . 3$$

In EQ. 1, EQ. 2, and EQ. 3, m denotes the number of testing examples, each training example being defined as an input-output pair, (xᵢ, yᵢ), for i=1, . . . , m, in which xᵢ is the input and yᵢ is the output associated with xᵢ. The associated outputs have an average

$$\overline{y} = \frac{1}{m} {\sum }_{i = 1}^{i = m} {y}_{i} .$$

A predicted output ŷᵢ denotes an output of the AI model receiving xᵢ as input, for i=1, . . . , m. The notation |⋅| denotes a norm that can be applied to the object in between. For example, if the outputs are real-valued, such as a value of a rate of penetration, the notation |⋅| may denote an absolute value. If the outputs are vector-valued, such as an encoded vector, the notation |⋅| may denote an l₂ norm. If the AI model is a classification model, an output yᵢ is a class within a plurality of classes Cⱼ, for j=1, . . . , C, where C denotes a number of classes in the classification. Examples of metrics that may be used to validate the classification AI model include an accuracy (ACC), defined as:

$$ACC = \frac{1}{m} {\sum }_{i = 1}^{i = m} δ ( {\hat{y}}_{i} , {y}_{i} ) . \qquad EQ . 4$$

In EQ. 4, δ is the symbol of Kronecker is defined by δ(ŷᵢ, yᵢ)=1 if ŷᵢ=yᵢ, or δ(ŷᵢ, yᵢ)=0 otherwise. In some embodiments, an output yᵢ may be expressed as a vector with components yᵢ^{j}, for j=1, . . . , C, where yᵢ^{j}=δ(yᵢ, Cⱼ). The associated output ŷᵢ is also a vector, with components ŷᵢ^{j}, each component denoting a probability score between 0 and 1, for j=1, . . . , C. In these embodiments, examples of metrics that may be used to validate the classification AI model include a categorical cross-entropy (CAT), defined as:

$$CAT = - \frac{1}{m} {\sum }_{i = 1}^{i = m} {\sum }_{j = 1}^{j = C} {y}_{i}^{j} log ( {\hat{y}}_{i}^{j} ) . \qquad EQ . 5$$

In one or more embodiments, the AI model (307) includes one or more regression models and one or more classification models. Examples of metrics that may be used to validate the AI model (307) include combinations of metrics taken from EQs. 1-5.

FIG. 4 depicts a system (400) for determining an optimum well intervention for a well operation. Given a second operating condition (403) as input, a reinforcement learning (RL) policy (405) returns, as output, a set of ratings (407). The set of ratings (407) includes one rating for each well intervention within a set of well interventions (409). A rating for a well intervention assesses how suitable the well intervention is to be performed in order to optimize the well operation. The higher the rating, the more suitable the well intervention is to optimize the well operation. In one or more embodiments, the ratings (407) sum to 1, forming a probability distribution for the set of well interventions (409). Examples of well interventions that may be included in the set of well interventions (409) are defined in other paragraphs of this disclosure and include hydraulic fracturing, acidizing, cementing, and water flooding. Furthermore, for simplicity in the description of the methods and systems in this disclosure, the set of well interventions (409) include an absence of well intervention called “do not intervene.” The “do not intervene” element of the set of well interventions (409) receives a rating from the RL policy (405), included in the ratings (407), as any other element of the set of well interventions (409). The RL policy (405) results from a RL model. Examples of RL models that may be used to determine the RL policy (405) include a Q-learning model, a deep Q-learning model, and a policy gradient model. The RL policy (405) may be of various types, depending on from which RL model the RL policy (405) was determined. In some embodiments, the RL policy (405) is a table that lists, for any possible value of the second operating condition (403), the ratings for all the well interventions among set of well interventions (409). In other embodiments, the RL policy (405) includes a neural network.

In some embodiments, all the well interventions within the set of well interventions (409) are relevant to the well operation (303). In other embodiments, the set of well interventions (409) includes well interventions that are relevant to well operations of any type, including, but not limited to, the well operation (303). Generally, the set of well interventions (409) is defined as the well interventions for which the RL policy (405) is configured. In one or more embodiments, a rating for a well intervention that is not relevant for the well operation (303) is lower than a rating for any well intervention that is relevant for the well operation (303). For instance, in some implementations, the well operation (303) is a drilling operation and the set of well interventions (409) includes a gas-lift. Since a gas-lift intervention is not relevant for a drilling operation, the rating for the gas-lift operation, output by the RL policy (405), is lower than a rating for a well intervention considered relevant for a drilling operation. Based on the ratings (407), an optimum well intervention (411) is selected from the set of well interventions (409). In one or more embodiments, the optimum well intervention (411) is selected as the well intervention that has the maximum rating within the ratings (407). It is noted that implementing the optimum well intervention (411) transforms the second operating condition (403) into a third operating condition. In some scenarios, the optimum well intervention (411) is the “do not intervene” intervention. That means, no well intervention is recommended for the well operation operating under the second operating condition (403). In such scenarios, the updated operating condition is equal to the second operating condition (403). In some implementations, the process from system (400) is repeated by feeding the third operating condition into the RL policy (405). Generally, the system (400) may be used multiple times, sequentially, to obtain an optimum well intervention sequence. A method for determining the optimum well intervention sequence by using the system (400) is described later this disclosure.

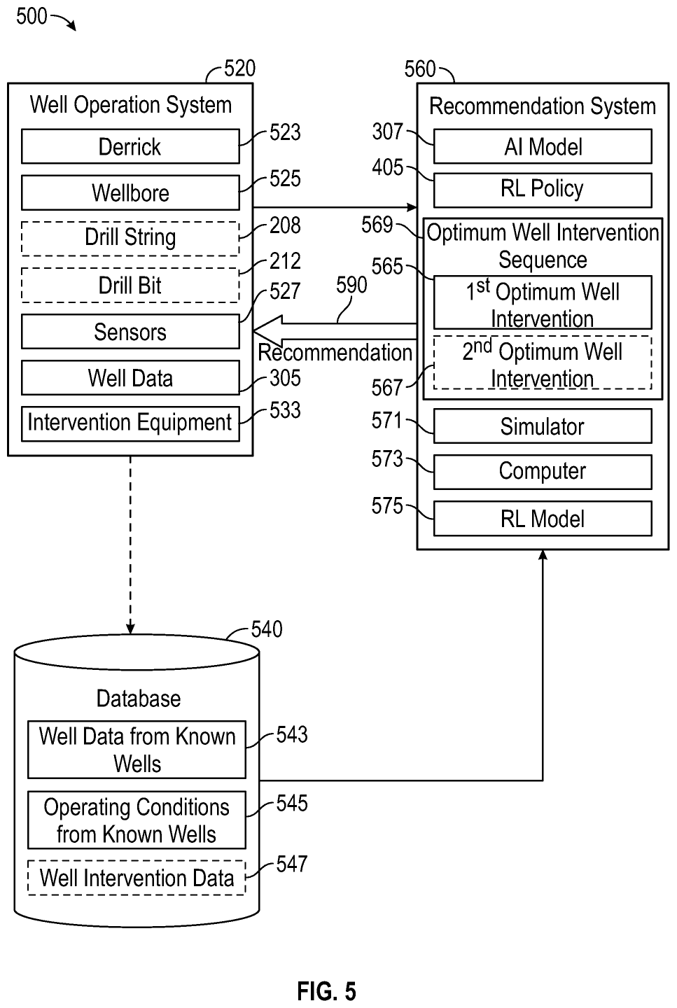

FIG. 5 depicts a system (500) for recommending an optimum well intervention sequence to a well operation, in accordance with one or more embodiments. The system (500) includes a well operation system (520), a database (540), and a recommendation system (560). The well operation system (520) is used to perform a well operation. Examples of the well operation performed by the well operation system (520) include a hydrocarbon production operation, such as the hydrocarbon production operation in FIG. 1. Examples for the well operation performed by the well operation system (520) further include a drilling operation, such as the drilling operation in FIG. 2. The well operation system (520) includes a derrick (523) and the well data (305). Examples of elements of the well data (305) include a seismogram, a composition of the rocks at the well location, a production fluid composition, a hydrocarbon production rate, a tubing specification, a crude oil property, a salinity of underground water, a density of the hydrocarbons, a velocity of the hydrocarbons through the wellbore (525), mud-flow rate, a drill bit vibration, a pressure, and a temperature. The well data (305) may be extracted from various sources, such as publications and well logs, or acquired by sensors (527) connected to a wellbore (525). Examples of sensors (527) include, but are not limited to, the sensors (119) in the hydrocarbon production operation well (101) and sensors (260) in the well site (200). The well operation system (520) further includes well intervention equipment (533) that may be used to perform a well intervention. Elements of the well intervention equipment (533) may include, for example, coil tubing, a wireline, a perforating gun, a hydraulic workover unit, and materials such as cement and acid. In one or more embodiments, the well operation system (520) further includes a drill string (208) or a drill bit (212), or both.

The well data (305) is sent to the recommendation system (560). The recommendation system (560) includes the AI model (307) described in the description of FIG. 3. In a similar fashion to FIG. 3, the AI model (307) receives the well data (305) as input and returns, as output, a first operating condition such as the first operating condition (309) in FIG. 3. The recommendation system (560) further includes the RL policy (405). Initially, an optimum well intervention sequence (569) is initialized as empty. Using the first operating condition as input, the RL policy (405) is used to determine a first optimum well intervention (565). The first optimum well intervention (565) may be performed as a step to optimize the performance of the well operation. The first optimum well intervention (565) is appended to the optimum well intervention sequence (569). The recommendation system (560) further includes a computer (573) on which the AI model (307) and the RL policy (405) are hosted and run. The recommendation system (560) further includes a simulator (571), which may also hosted and run on the computer (573) or another similar computer. Given an input operating condition and an input well intervention the simulator (571) returns a prediction of an output operating condition that would result from implementing the input well intervention to the well operation operating under the input operating condition.

In one or more embodiments, the simulator (571) is applied to the first operating condition and first optimum well intervention (565) and returns, as output, a second operating condition. Then, using the second operating condition as input, the RL policy (405) may be used again to determine a second optimum well intervention (567). Then, using the second operating condition and the second optimum well intervention (567) as inputs, the simulator (571) may be used to predict a third operating condition resulting from the second optimum well intervention. It follows that a prediction process is defined by predicting a simulated operating condition using the simulator (571) and inputting the simulated operating condition to the RL policy (405) to obtain an optimum well intervention. Repeating the prediction process until a pre-defined stopping criterion is met results in an optimum well intervention sequence (569). The stopping criterion may be defined in many ways. In some embodiments, the stopping criterion is a pre-defined number of iterations of the prediction process. As a specific example, the prediction process might be run only once, forcing the optimum well intervention sequence (569) to composed of the sole first optimum well intervention (565). In some embodiments, the stopping criterion is based on a performance of the well operation and the prediction process is repeated until the performance is optimum.

The optimum well intervention sequence (569) is recommended to be performed by the well operation system (520) through the recommendation (590). The optimum well intervention sequence (569) is performed using the well intervention equipment (533). The recommendation system (560) further includes a RL model (575), which may be hosted and run on the computer (573) or another similar computer. The RL model (575) is used to determine the RL policy (405). A state of the RL model (575) is an operating condition. An action of the RL model (575) is a well intervention. An environment for the RL model (575) includes the simulator (571) that transforms, through an action, a first state into a second state. In some embodiments, the RL model (575) includes a Markov decision process. Examples for the RL model (575) include a Q-learning model, a deep Q-learning model, and a policy gradient model.

Examples for the simulator (571) include a physical model such as multi-phase fluid flow in porous media. The multi-phase fluid flow in porous media combines advection, diffusion, and reaction in a reservoir rock to predict, from an initial condition, a volume fraction of each phase of the production fluid at a certain time in the reservoir rock. The multi-phase fluid flow should be adaptive to the operating condition. For example, if the well intervention includes cementing, the new cement may constitute a new boundary for the domain of the multi-phase fluid flow. Examples for a physical model included in the simulator (571) further include a heat equation for modeling a temperature under any given operating condition. Examples for physical model included in the simulator (571) further include a rock physical model modeling a hydraulic fracturing operation. Examples for a physical model included in the simulator (571) further include a one-dimensional formula that averages any of the foregoing physical models. Examples for the simulator (571) further include a physical formula that does not include partial derivatives such as a Bernoulli equation. A Bernoulli equation may relate, for example, the pressure and the density of the production fluid, or the density and pressure of gas used in a gas lift operation. Examples for the simulator (571) further include a chemical formula, for example, modeling a chemical reaction between an acid and a reservoir rock resulting from an acidizing intervention. In some embodiments, the simulator (571) includes a numerical solver that discretizes partial differential equations. Examples of a numerical solver include a finite element method and a finite volume method. In some embodiments, the simulator (571) makes use of AI. In that regard, the simulator (571) may include a supervised machine learning (ML) model configured to receive the first operating condition and the well intervention as input and predict the second operating condition as output. Using recorded operating conditions and well interventions performed on pre-existing wells, the supervised ML model may be trained by optimally matching pairs of operating conditions and well interventions to corresponding, resulting operating conditions. Examples of supervised ML models that may be included in the simulator (571) include a regression model, a support vector machine, and a deep neural network. In some embodiments, the simulator (571) further includes a virtual reality system that mimics well interventions.

The process performed by the well operation system (520) and recommendation system (560) may be repeated multiple times. After the optimum well intervention sequence (569) has been completed, the well data (305) may be obtained again and sent to the recommendation system (560) to obtain a new optimum well intervention sequence (569). The system (500) further includes a database (540). The database (540) includes well data from known wells (543) and operating conditions from known wells (545), corresponding to the well data from known wells (543). The well data from known wells (543) and operating conditions from known wells (545) are used to create a dataset of input-output pairs to train and test the AI model (307). Note that during the drilling operation, the AI model (307) may be re-trained or fine-tuned using the database (540). In one or more embodiments, the operating conditions computed by the AI model (307) during the well operation are validated through one or more tests (e.g., well log analysis) against the well data (305). In such scenarios, the validated operations may be appended to the operating conditions from known wells (545) in the database (540), and the associated well data (305) may likewise be appended to the well data from known wells (543) in the database (540). In this way, newly acquired data may be used to train, re-train, or fine tune the AI model (307). Re-training or fine-tuning the AI model (307) using newly acquired data is known as a first feedback loop for the AI model (307). In a similar fashion, a second feedback loop may be defined for the RL model (575). After performing a well intervention, called a field well intervention, the well data (305) may be obtained again and input to the AI model (307) to obtain a feedback output operating condition. The feedback output operating condition is obtained by actually performing a well intervention and acquiring new well data (305) rather than using the simulator (571). Thus, in some embodiments, the feedback output operating condition is considered to be more reliable than a simulated operating condition from the simulator (571). The first operating condition, field well intervention, and resulting feedback output operating condition may be appended to the database (540) as well intervention data (547). The well intervention data (547) may be used to re-train or fine-tune the RL model (575) resulting in an updated RL policy (405).

As stated, the RL policy (405) is obtained by using the RL model (575). The RL model (575) can be of many types, including, as non-limiting examples, a Q-learning model, a deep Q-learning model, and a policy gradient model. RL models, regardless of their specific implementation, commonly include an environment, a plurality of states, a plurality of actions, and a reward function. An action transforms a first state into a second state. The environment is a framework that performs or simulates an action. The reward function provides a score resulting from applying an action to the first state. In the context of this disclosure, a state is an operating condition and an action is a well intervention. A well intervention transforms a first operating condition into a second operating condition. The environment includes, at least, the simulator (571) that simulates the well intervention. In one or more embodiments, the environment further includes the second feedback loop described in the description of FIG. 5. The second feedback loop includes forming feedback triplets composed of a first operating condition, a field well intervention, and a feedback output operating condition. Then, in situations where the environment receives, as input, a first operating condition and a field well intervention from a feedback triplet, the environment returns, as output, the feedback output operating condition from the same feedback triplet. The simulator (571) is not used if the input to the environment is composed of a first operating condition and a field well intervention from a feedback triplet. The reward is a score given to the well intervention when applied to the first operating condition.

Assuming that a given well intervention transforms a first operating condition into a second operating condition, the reward is based on, at least, the second operating condition. In some implementations, the reward further depends on the first operating condition, the well intervention, or both. The reward can be defined in many ways and the operations that are made to determine the reward are said to form a reward model. As such, the reward is determined by using the reward model. In some embodiments, the reward model is based on the performance of the well operation. A first performance is obtained for the first operating condition. A second performance is obtained for the second operating condition. Then, the reward is computed depending on a difference between the second performance and the first performance. As such, the reward model is based on a gain in performance resulting from applying the well intervention to the first operating condition. In some implementations, the performance of the well operation operating under a given operating condition is part of the given operating condition. In other implementations, the performance of the well operation can be modeled and computed using a performance model. The performance model can be defined in many ways depending on how the performance of the well operation is defined. In one or more embodiments, the performance is computed using a physical model that receives the given operating condition as input. In one or more embodiments, the performance model makes use of AI.

In one or more embodiments, the reward is based on one or more of a success rate, a cost, a time efficiency, and an environmental impact of the well intervention. The success rate of the well intervention is a probability that the well intervention succeeds. In some implementations, the time efficiency of the well intervention is an inverse of a duration of the well intervention. Depending on a nature of the well intervention, the well intervention may have an impact on the environment. For instance, hydraulic fracturing modifies rocks surrounding the well. Similarly, acidizing releases acid in underground rocks and may be associated with a pollution of the reservoir. Furthermore, some well interventions such as water flooding may displace fluids to unknown territories. In some embodiments, the environmental impact of the well intervention is a measure of how much the well intervention modifies the environment. In some implementations, the environmental impact is a categorical score, such as an ordinal number between 1 and 10, with 1 associated with a lowest environmental impact and 10 associated with a highest environmental impact. The success rate, cost, time efficiency and environmental impact of the well intervention may be obtained, for example, by using a statistical inference from one or more prior experiences of applying the well intervention to existing wells.

RL models include algorithms that compute a final RL policy (the RL policy (405)) from an initial RL policy. Such algorithms seek to maximize a weighted sum of rewards resulting from recursively applying a sequence of actions from an initial state. One with ordinary skill in the art will recognize that a full discussion of every type of RL model applicable to the methods and systems in this disclosure is not possible nor required to describe the systems and methods in this disclosure. As an example, a brief discussion and summary of a deep Q-learning (DQL) model is provided herein. However, it is noted that many variations of a DQL model exist. Therefore, one with ordinary skill in the art will recognize that any variation of the DQL model (or any other RL model) may be employed without departing from the scope of this disclosure. Further, it is emphasized that the following discussions of a DQL model is a basic summary, provided by way of introduction to the art of reinforcement learning and does not impose a limitation on the present disclosure.

A RL policy resulting from a DQL model is a neural network, called a Q-network, that receives an input operating condition and returns a rating for each well intervention with the set of well interventions (409). Examples for the Q-network include a fully connected neural network, a convolutional neural network, a recurrent neural network, or any combination thereof. The Q-network is trained using a plurality of inputs and associated outputs. For a purpose of training the Q-network, the DQL model further includes an auxiliary neural network, called a target-network. The target network is not trained. The target network is updated as a copy of the on-training Q-network at a specific set of target epochs of the training of the Q-networks. During the training of the Q-network, the Q-network is copied into the target network every time a target epoch is reached. The target network remains constant between two consecutive target epochs.

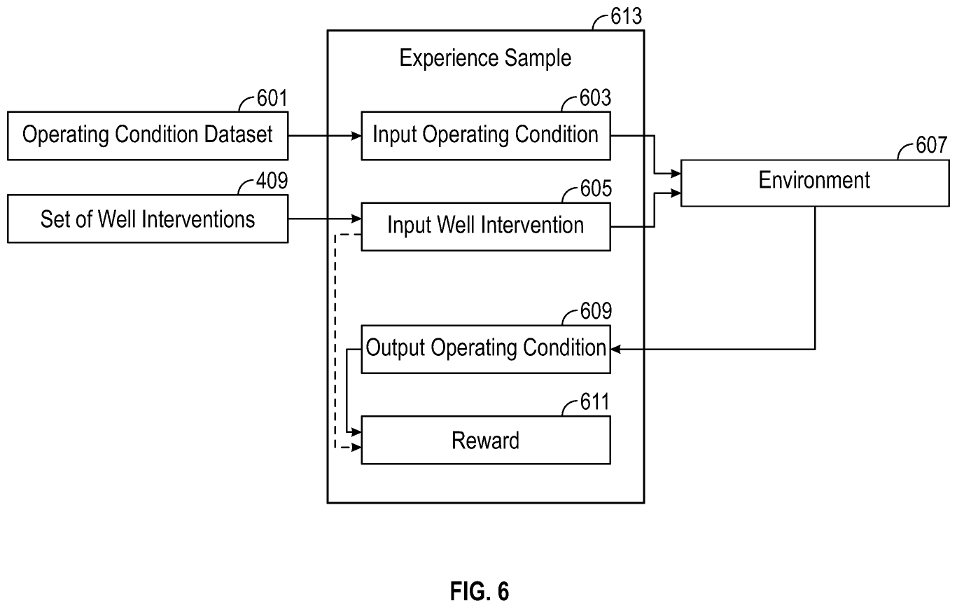

A first step of the DQL model is to collect a plurality of experience samples, each experience sample composed of four elements: an input operating condition, a well intervention, an output operating condition resulting from applying the well intervention to the input operating condition, and a reward resulting from applying the well intervention to the input operating condition. FIG. 6 depicts a system for determining an experience sample, in accordance with one or more embodiments. An operating condition dataset (601) includes one or more example operating conditions. The example operating conditions in the operating condition dataset (601) may be obtained from various sources. For instance, one or more example operating conditions may be obtained from a database, such as the database (540) that is used to train the AI model (307) in FIG. 5. In one or more embodiments, some of the example operating conditions are determined by first obtaining well data for one or more wells, forming a well dataset. Well data in the well dataset may be obtained in a same fashion as the well data (305) in FIG. 3, or extracted from the database (540) in FIG. 5. Then, applying the AI model (307) to each element of the well dataset yields example operating conditions. In one or more embodiments, some of the example operating conditions are synthetized. For instance, in some implementations, an operating condition is defined as a set (\tilde{c}₁, \tilde{c}₂, \tilde{c}₃), where the pressure stability status c₁ is set to 1 if the pressure is stable, or 0 otherwise, the temperature normality status \tilde{c}₂ is set to 1 if the temperature is normal, or 0 otherwise and the gas migration status \tilde{c}₃ is set to 1 if no gas migration is occurring, or 0 otherwise. In such scenarios, eight example operating conditions can be synthesized: (1,1,1), (1,1,0), (1,0,1), (1,0,0), (0,1,1), (0,1,0), (0,0,1) and (0,0,0).

An input operating condition (603) is taken from the operating condition dataset (601). An input well intervention (605) is taken from the set of well interventions (409). In some implementations, the input operating condition (603) is selected randomly. In some implementations, the input well intervention (605) is selected randomly. Then, the input well intervention (605) is simulated by using an environment (607) with the input operating condition (603) as input. The environment (607) outputs an output operating condition (609). A reward (611) is computed by using a reward model based on, at least, the output operating condition (609). In some embodiments, the reward model is further based on the input operating condition (603), the input well intervention (605), or both. An experience sample (613) is formed as the input operating condition (603), the input well intervention (605), the output operating condition (609), and the reward (611). In some implementations, the environment (607) is the simulator (571). In other implementations, the environment (607) includes the simulator (571). The simulator (571) includes one or more simulation models. The one or more simulation models may include, for example, one or more of a multi-phase fluid flow model, a heat equation, a rock physical model, a Bernoulli equation, a chemical formula, and a virtual reality system. Each of the one or more simulation models is adapted to one or more well interventions within the set of well interventions (409). For instance, a multi-phase fluid flow model may be used to simulate a water flooding intervention and a flow resulting from a cementing intervention. A rock physical model may be used to simulate a hydraulic fracturing intervention.

In one or more embodiments, the environment (607) further includes a feedback loop. The feedback loop includes one or more feedback triplets. Each feedback triplet is composed of a first input operating condition, a field well intervention, and a feedback output operating condition. The field well intervention was performed on the well operating under the first operating condition. Feedback well data is obtained for the well operation as soon as feasible after the field well intervention has been performed. The feedback well data is obtained in a similar fashion to the well data (305) in FIGS. 3 and 5. The feedback output operating condition is obtained by applying the AI model (307) to the feedback well data. The feedback loop further includes a feedback mapping defined for each feedback triplet within the one or more feedback triplets. For each feedback triplet the feedback mapping receives, as input, the feedback input operating condition and the field well intervention and returns, as output, the feedback output operating condition. The environment (607) makes use of the feedback loop as follows: if the input operating condition (603) and the input well intervention (605) are equal to a first input operating condition and a field well intervention from a given feedback triplet within the one or more feedback triplets, the environment returns, as the output operating condition (609), the feedback output operating condition from the given triplet. The simulator (571) is not used to compute the output operating condition (609) in this case.

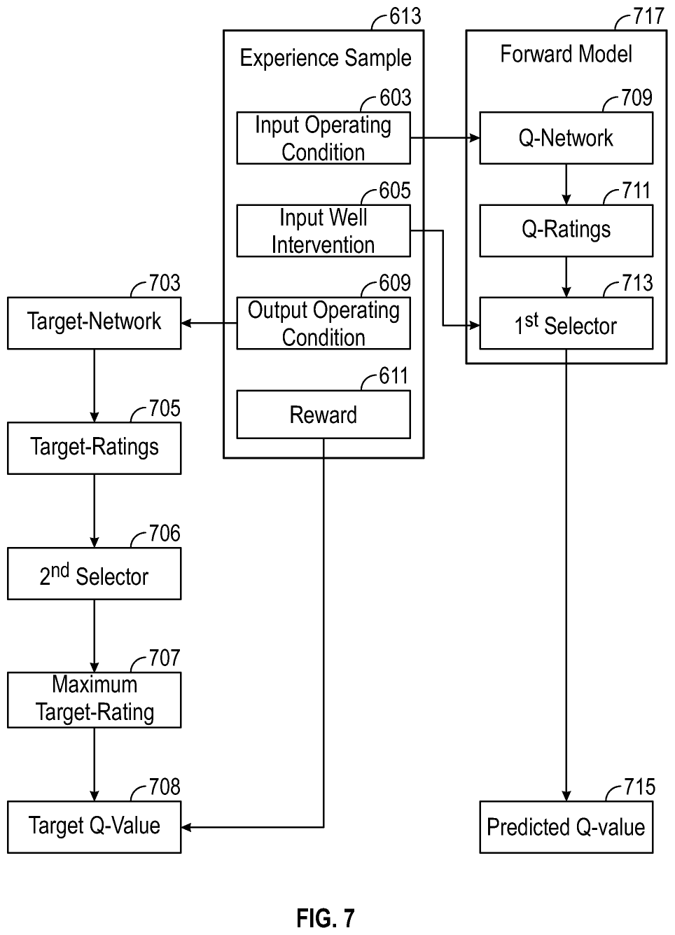

FIG. 7 depicts a forward model (717) that is used to train a Q-network (709). The Q-network (709) receives, as input, the input operating condition (603) from the experience sample (613) and returns, as output, Q-ratings (711) for all the well interventions within the set of well interventions (409). The Q-ratings (711) form a vector of real numbers. Each component of the Q-ratings (711) is a rating for a distinct well intervention within the set of well interventions (409). The number of components of the Q-ratings (711) is the number of well interventions within the set of well interventions (409). During the training of the Q-network, the RL policy has not yet been determined. Therefore, the Q-ratings (711) do not represent ratings returned by the RL policy. After training the Q network, the RL policy is the trained Q-network and the Q-ratings (711) are the ratings determined by the RL policy. A predicted Q-value (715) is extracted from the Q-ratings (711) using a first selector (713). The first selector (713) extracts, from the Q-ratings (711), a value of the component corresponding to the input well intervention (605) from the experience sample (613). The forward model (717) consists of applying, sequentially, the Q-network (709) and the first selector (713) to the experience sample (613) to obtain. The forward model (717) receives, as input, the input operating condition (603) and the input well intervention (605) and returns, as output, the predicted Q-value (715).

The Q-network has weights that need to be trained using training examples. FIG. 7 further includes a system that determines, from the experience sample (613), a training example used to train the Q-network (709). The training example is composed of an input and an associated output (i.e., target). The input is composed of the input operating condition (603) and the input well intervention (605) from the experience sample (613). The associated output is a target Q-value (708). To compute the target Q-value (708) the output operating condition (609), from the experience sample (613), is fed into a target network (703). As described in other paragraphs of this disclosure, the target network (703) is updated as a copy of the on-training Q-network at target epochs of the training of the Q-network (709). The target network (7)3) remains constant between two consecutive target epochs. The target network (703) returns, as output, a vector of target-ratings (705). In a similar fashion to the Q-ratings (711), each component of the target-ratings (705) is a rating for a distinct well intervention within the set of well interventions (409). However, while the Q-ratings (711) originate from the input operating condition (603), the target-ratings (705) originate from the output operating condition (609). Therefore, the target-ratings (705) represents future ratings for the well interventions within the set of well interventions (409). A maximum target-rating (707), denoted as Qₘₐₓ, is extracted from the target-ratings (705) using a second selector (706). The maximum target-rating (707) is a maximum of values of the components of the target-ratings (705). Denoting R as the reward (611) from the experience sample (613), the target Q-value (708) is computed as

$$Target Q - value = R + {γ Q}_{max} . \qquad EQ . 6$$

In EQ. 6, γ∈[0,1) is a real number called a discount rate. The training example defined in FIG. 7 is composed of the input, composed of the input operating condition (603) and the input well intervention (605) from the experience sample (613), and the associated output, equal to the target Q-value (708). Given a plurality of training examples, the Q-network (709) may be trained by updating the weights to optimally match the predicted Q-value (715) and the target Q-value (708) derived from each training example.

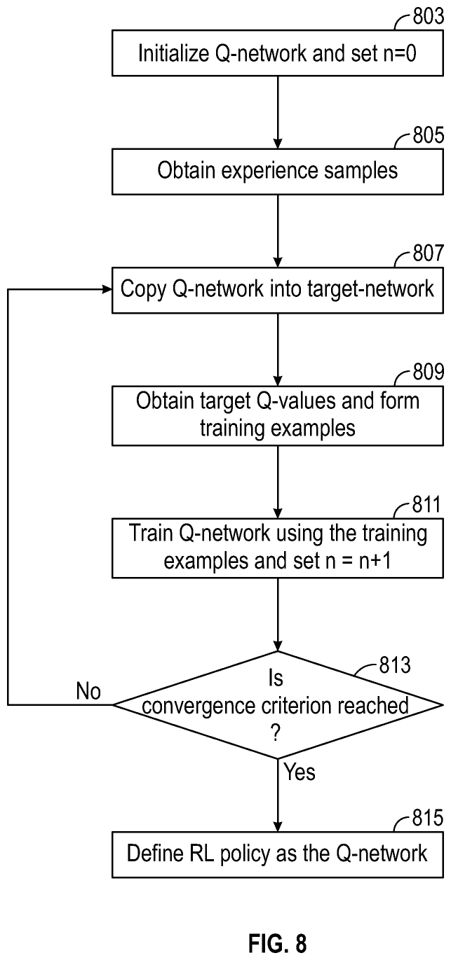

FIG. 8 depicts a DQL model that may be used to determine the RL policy (405). A stated, the DQN model includes two neural networks: a Q-network such as the Q-network (709) and a target-network such as the target network (703). The Q-network and target-network may be of various types and may include, in some embodiments, a fully connected neural network, a convolutional neural network, a recurrent neural network, or any combination thereof. In Step 803, the Q-network is initialized, and an iterator n, called a target iterator, is set to 0. Examples of methods for initializing the Q-network include, for example, setting weights of the Q-network to 0. Examples of methods for initializing the Q-network further include a Xavier initialization. In Step 805, a plurality of experience samples is obtained by using the system in FIG. 6. Each experience sample includes an input operating condition (603), an input well intervention (605), an output operating condition (609), and a reward (611). In Step 807, the target-network is defined as a copy of the Q-network. In Step 809, a target Q-value is computed from each experience sample from Step 805 resulting in a plurality of target Q-values. For each experience sample, the target Q-value is computed in a same way as the target Q-value (708) is computed for the experience sample (613) in FIG. 7. A plurality of training examples is formed. Each training example is obtained from a given experience sample and includes an input and associated output (i.e., target). The input is composed of an input operating condition and an input well intervention from the given experience sample. The associated output is the target Q-value derived from the experience sample.

In Step 811, the Q-network is trained using the training examples from Step 809. The Q-network is trained by adjusting the weights, denoted as w, of the Q-network. The weights w are adjusted in a way that predicted Q-values obtained by applying the forward model (717) to the inputs from the training examples from Step 809 optimally match the corresponding target Q-values from the training examples from Step 809. Denoting M as a number of training examples obtained in Step 809, xᵢ as the input from (i.e., input operating condition and input well intervention) from a training example and yᵢ as the target (i.e., target Q-value) associated with xᵢ, for i=1, . . . , M, a predicted Q-value ŷᵢ(w) is computed by applying the forward model (717) in FIG. 7 to the input xᵢ. The forward model (717) depends on the weights w of the Q-network. Thus, the predicted Q-value ŷᵢ(w) also depend on the weights w of the Q-network. Training the Q-network in Step 811 can be done in many ways. In one or more embodiments, training the Q-network is based on finding weights w* that minimize an average error, E, between the predicted Q-values and corresponding target Q-values. This means that w* is solution to the following minimization problem:

$$find {w}^{*} such that for all weights w , E ( {w}^{⋆} ) \leq E ( w ) . \qquad EQ . 7$$

In EQ. 7, the average error E can be defined in several ways. As a non-limiting example, the average error E may be defined as a mean-squared error:

$$E ( w ) = \frac{1}{M} {\sum }_{i = 1}^{i = M} {\vert {\hat{y}}_{l} ( w ) - {y}_{i} \vert}^{2} . \qquad EQ . 8$$

In some implementations, training the Q-network consists of finding optimum weights as a solution to a solver that seeks to solve the minimization problem in EQ. 7. Examples of solvers that may be used to seek a solution to the minimization problem in EQ. 7 include, but are not limited to, gradient methods, such as a gradient descent method or a conjugate gradient method. After the Q-network has been trained, the target iterator n is incremented as n=n+1.

In Step 813, a convergence test is performed. If a convergence criterion is reached, the RL policy is defined as the Q-network in Step 815 and the algorithm stops. If the convergence criterion is not reached, Steps 807-813 are re-iterated. Re-iterating the steps 807-813 include Step 807, in which the target-network is updated as a copy of the newly trained Q-network. The convergence criterion in Step 813 can be defined in many ways. In one or more embodiments, the convergence criterion in Step 813 is a maximum number of target iterations nₘₐₓ and the convergence criterion is reached if and only if n=nₘₐₓ. It is noted that the DQL model in FIG. 8 is given as an example of a DQL model and should be considered non-limiting. The skilled in the art will readily appreciate that many variants of a DQL model may be employed without departing from the scope of this disclosure. Examples of variants include using mini-batches of experience samples for training the Q-network, instead of using all the experience samples from Step 805. Further variants include selecting the experience samples in Step 805 using an epsilon-greedy technique known in the art.

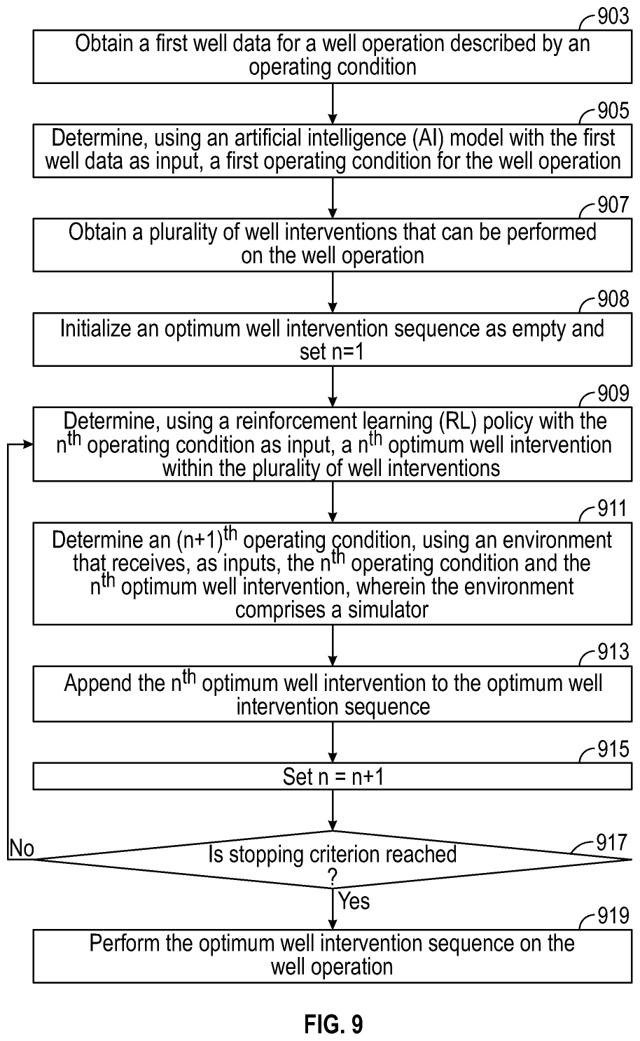

FIG. 9 depicts a method for obtaining an optimum well intervention sequence intended to optimize the performance of a well operation, in accordance with one or more embodiments. The method in FIG. 9 combines two AI procedures. First, an AI model is used to compute an operating condition of a well operation, using well data as input. Then, a RL policy receives the operating condition as input and returns an optimum well intervention to be performed to optimize the well operation. For concision, a full description of components and/or elements depicted in FIG. 9 is not provided anew for those components and/or elements that have be previously described with reference to the preceding figures. In Step 903, well data is obtained for the well operation in a similar fashion as the well data (305) is obtained in FIG. 3. The well operation is described by an operating condition. In Step 905, a first operating condition is determined using the first well data as input to the AI model (307) in a similar fashion to the first operating condition (309) is determined in FIG. 3. In Step 907, a plurality of well interventions is obtained in a similar manner as the set of well interventions (409) is obtained in FIG. 4. Examples of well interventions are defined in other paragraphs of this disclosure and include hydraulic fracturing, acidizing, cementing, and water flooding. As described in the description of FIG. 4, the plurality of well interventions in Step 907 includes an absence of well intervention called “do not intervene,” meaning that no intervention is recommended. In Step 908, an optimum well intervention sequence is initialized as an empty set and an iterator n is initialized to 0. In Step 909, a n^{th} optimum well intervention is determined using the RL policy (405) in a same fashion as how the optimum well intervention (411) is determined in FIG. 4. The input to the RL policy (405) in Step 909 is the n^{th} operating condition. The output of the RL policy (405) in Step 909 includes ratings for each well intervention within the set of well interventions from Step 907. The n^{th} optimum well intervention is then determined by selecting the well intervention with a maximum rating. In some embodiments, the RL policy (405) is a table that lists, for any possible value of the n^{th} operating condition, the ratings for all the well interventions within the set of well interventions (409). In other embodiments, the RL policy (405) is a neural network.

In Step 911, a (n+1)^{th} operating condition is determined as a result of applying the n^{th} optimum well intervention to the n^{th} operating condition. The (n+1)^{th} operating condition is determined by using an environment, such as the environment (607) in FIG. 6. The environment includes, at least, a simulator, such as the simulator (571) in FIG. 5. The environment receives, as inputs, the n^{th} operating condition and the n^{th} optimum well intervention and returns, as output, the (n+1)^{th} operating condition. In Step 913, the n^{th} optimum well intervention is appended to the well intervention sequence. In Step 915, the iterator n is incremented by 1. In Step 917, a convergence test is performed. If a stopping criterion is reached, then the optimum well intervention sequence is complete and the optimum well intervention sequence is performed on the well operation in Step 919. If the stopping criterion is not reached, the steps 909-917 are repeated. The stopping criterion may be defined in many ways. In some embodiments, the stopping criterion is a pre-defined number of iterations nₘₐₓ and the stopping criterion is reached if and only if n=nₘₐₓ. In a specific scenario where nₘₐₓ is set to 1, the well intervention sequence includes a single well intervention: the 0^{th} optimum well intervention. In some embodiments, the stopping criterion is based on an optimality of the performance of the well operation. The performance of the well operation is assessed based on the (n+1)^{th} operating condition. If the performance is optimum, the stopping criterion is reached. If the performance is not optimum, the stopping criterion is not reached. The performance of the well operation can be defined in many ways and examples of performances and their optimality are detailed in other paragraphs of this disclosure.

In some embodiments, the stopping criterion is based on a distance between the (n+1)^{th} operating condition and the n^{th} operating condition. If the distance is smaller than or equal to a pre-defined convergence threshold, the stopping criterion is reached. If the distance is greater than a pre-defined convergence threshold, the stopping criterion is not reached. A distance between the (n+1)^{th} operating condition and the n^{th} operating condition can be defined in many ways depending, at least, on the operating condition type. If the n^{th} and (n+1)^{th} operating conditions are numerical, represented by real numbers or vectors of real numbers, examples of distances that may be computed between the (n+1)^{th} operating condition and the n^{th} operating condition include an Euclidian distance. If the n^{th} and (n+1)^{th} operating conditions are categorical, examples of distances that may be computed between the (n+1)^{th} operating condition and the n^{th} operating condition include a Kronecker distance subtracted from 1. If the n^{th} and (n+1)^{th} operating conditions include numerical and categorical values, examples of distances that may be computed between the (n+1)^{th} operating condition and the n^{th} operating condition include a combination of one or more Euclidian distances and one or more Kronecker distances. As an example, assume that the operating condition type is composed of a numerical value P, an encoded vector, V, and a categorical class, c. Denoting the n^{th} operating condition as (Pₙ, Vₙ, cₙ) and the (n+1)^{th} operating condition as (Pₙ₊₁, Vₙ₊₁, cₙ₊₁), an example of a distance between the (n+1)^{th} operating condition and the n^{th} operating condition is |Pₙ₊₁−Pₙ|+∥Vₙ₊₁−Vₙ∥ₗ_{²}+(1−δ(cₙ, cₙ₊₁)), where δ(cₙ, cₙ₊₁)=1 if cₙ=cₙ₊₁, or (cₙ, cₙ₊₁)=0 otherwise. A notable example of reaching the stopping criterion based on the distance between the (n+1)^{th} operating condition and the n^{th} operating condition may occur when the n^{th} optimum well intervention in Step 909 is the “do not intervene” intervention (i.e., the RL policy determines that no intervention is needed). In such scenarios, the (n+1)^{th} operating condition and the n^{th} operating condition are equal and the distance between the (n+1)^{th} operating condition and the n^{th} operating condition is zero, implying that the stopping criterion in Step 917 is reached.

In one or more embodiments, a training event may be conducted, where the optimum well intervention is taught to be a solution to optimize the performance of the well operation of the well operation when operating under the first operating condition. In some implementations, a command system sends a command to recommend and perform the optimum well intervention sequence in Step 919. The command system may further be used to send a command to conduct the training event. The command system includes resources, such as hardware, software, and human resources. The command system may access the well operation, well data, and intervention equipment. The command system may operate and interact with the systems described in this disclosure. The command system may send a request to determine an optimum intervention sequence to optimize the well intervention using the method in FIG. 9. The command system may use exterior inputs based on contracts, service providers, materials, a scope of work for a well operation, a cost of the well intervention operation, and various restrictions (such as alternate restrictions for different well interventions).

As stated, some of the methods and systems defined in this disclosure include artificial intelligence (AI). For instance, the systems in FIGS. 3, 5, and the method in FIG. 9 include the AI model (307). The RL policy (405) may include a neural network. The simulator (571) may include a machine learning model. Artificial intelligence, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI) will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A notable example of an AI model that may be included in AI model (307), the RL policy (405) or the simulator (571) is a neural network (NN), such as a convolutional neural network (CNN) or a recurrent neural network (RNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

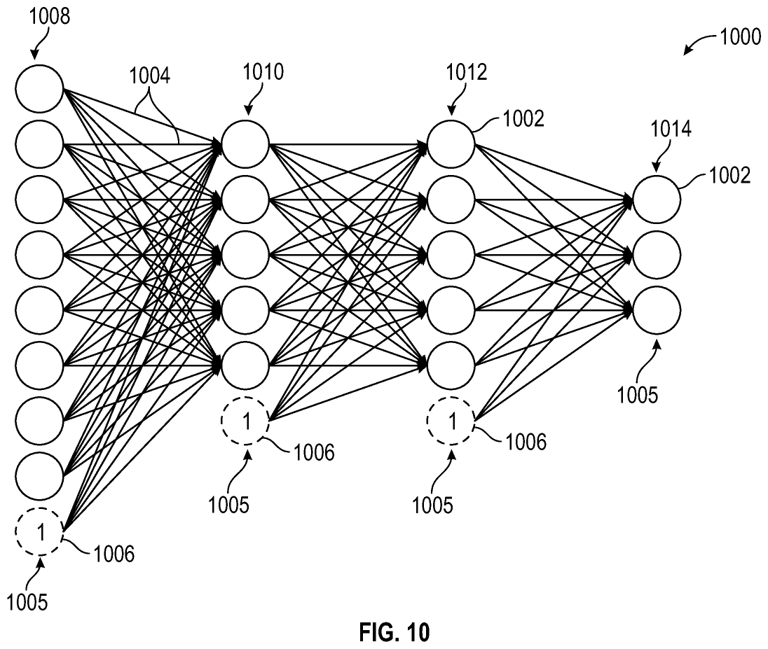

A diagram of a neural network is shown in FIG. 10. At a high level, a neural network (1000) may be graphically depicted as being composed of nodes (1002), where here any circle represents a node, and edges (1004), shown here as directed lines. The nodes (1002) may be grouped to form layers (1005). FIG. 10 displays four layers (1008, 1010, 1012, 1014) of nodes (1002) where the nodes (1002) are grouped into columns, however, the grouping need not be as shown in FIG. 10. The edges (1004) connect the nodes (1002). Edges (1004) may connect, or not connect, to any node(s) (1002) regardless of which layer (1005) the node(s) (1002) is in. That is, the nodes (1002) may be sparsely and residually connected. A neural network (1000) will have at least two layers (1005), where the first layer (1008) is considered the “input layer” and the last layer (1014) is the “output layer.” Any intermediate layer (1010, 1012) is usually described as a “hidden layer.” A neural network (1000) may have zero or more hidden layers (1010, 1012) and a neural network (1000) with at least one hidden layer (1010, 1012) may be described as a “deep” neural network or as a “deep learning method.” In general, a neural network (1000) may have more than one node (1002) in the output layer (1014). In this case the neural network (1000) may be referred to as a “multi-target” or “multi-output” network.

Nodes (1002) and edges (1004) carry additional associations. Namely, every edge is associated with a numerical value. The edge numerical values, or even the edges (1004) themselves, are often referred to as “weights” or “parameters.” While training a neural network (1000), numerical values are assigned to each edge (1004). Additionally, every node (1002) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) \qquad EQ . 9$$

where i is an index that spans the set of “incoming” nodes (1002) and edges (1004) and ƒ is a user-defined function. Incoming nodes (1002) are those that, when the neural network (1000) is viewed or depicted as a directed graph (as in FIG. 10), have directed arrows that point to the node (1002) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (1002) in a neural network (1000) may have a different associated activation function. Often, as a shorthand, activation functions are described by the function ƒ by which it is composed. That is, an activation function composed of a linear function ƒ may simply be referred to as a linear activation function without undue ambiguity.

When the neural network (1000) receives an input, the input is propagated through the network according to the activation functions and incoming node (1002) values and edge (1004) values to compute a value for each node (1002). That is, the numerical value for each node (1002) may change for each received input. Occasionally, nodes (1002) are assigned fixed numerical values, such as the value of 1, that are not affected by the input or altered according to edge (1004) values and activation functions. Fixed nodes (1002) are often referred to as “biases” or “bias nodes” (1006), displayed in FIG. 10 with a dashed circle.

In some implementations, the neural network (1000) may contain specialized layers (1005), such as a normalization layer, or additional connection procedures, like concatenation. One skilled in the art will appreciate that these alterations do not exceed the scope of this disclosure.

As noted, the training procedure for the neural network (1000) comprises assigning values to the edges (1004). To begin training the edges (1004) are assigned initial values. These values may be assigned randomly, assigned according to a prescribed distribution, assigned manually, or by some other assignment mechanism. Once edge (1004) values have been initialized, the neural network (1000) may act as a function, such that it may receive inputs and produce an output. As such, at least one input is propagated through the neural network (1000) to produce an output. Training data is provided to the neural network (1000). Generally, training data consists of pairs of inputs and associated targets. The targets represent the “ground truth,” or the otherwise desired output, upon processing the inputs. For instance, in the context of the AI model (307), an input is a well data that is known from an existing well and an output, or target, is an operating condition for the existing well, the operating condition associated with the well data. During training, the neural network (1000) processes at least one input from the training data and produces at least one output. Each neural network (1000) output is compared to its associated input data target. The comparison of the neural network (1000) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (1000) output and the associated target. The loss function may also be constructed to impose additional constraints on the values assumed by the edges (1004), for example, by adding a penalty term, which may be physics-based, or a regularization term. Generally, the goal of a training procedure is to alter the edge (1004) values to promote similarity between the neural network (1000) output and associated target over the training data. Thus, the loss function is used to guide changes made to the edge (1004) values, typically through a process called “backpropagation”.

While a full review of the backpropagation process exceeds the scope of this disclosure, a brief summary is provided. Backpropagation consists of computing the gradient of the loss function over the edge (1004) values. The gradient indicates the direction of change in the edge (1004) values that results in the greatest change to the loss function. Because the gradient is local to the current edge (1004) values, the edge (1004) values are typically updated by a “step” in the direction indicated by the gradient. The step size is often referred to as the “learning rate” and need not remain fixed during the training process. Additionally, the step size and direction may be informed by previously seen edge (1004) values or previously computed gradients. Such methods for determining the step direction are usually referred to as “momentum” based methods.

Once the edge (1004) values have been updated, or altered from their initial values, through a backpropagation step, the neural network (1000) will likely produce different outputs. Thus, the procedure of propagating at least one input through the neural network (1000), comparing the neural network (1000) output with the associated target with a loss function, computing the gradient of the loss function with respect to the edge (1004) values, and updating the edge (1004) values with a step guided by the gradient, is repeated until a termination criterion is reached. Common termination criteria are: reaching a fixed number of edge (1004) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (1004) values are no longer intended to be altered, the neural network (1000) is said to be “trained”.

A structural grouping, or group, of weights is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (1000), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (1000) to produce a final output. Note, that in this context, the neural network (1000) is still considered part of the CNN. Like unto a neural network (1000), a CNN is trained, after initialization of the filter weights, and the edge (1004) values of the internal neural network (1000), if present, with the backpropagation process in accordance with a loss function.

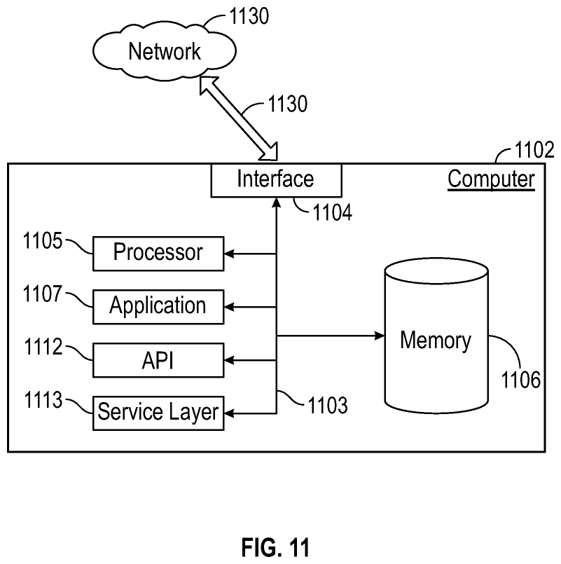

The computations mentioned in this disclosure may be performed by a computer, such as the computer (573) in FIG. 5. In that regard, FIG. 11 depicts a block diagram of a computer (1102) used to provide computational functionalities associated with described algorithms, methods, functions, processes, flows, and procedures as described in this disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. In some implementations, one or more components of the computer (1102) may be configured to operate within environments, including cloud-computing-based, local, global, or other environments (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). The memory may be a non-transitory computer readable medium. For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers such as the computer (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers such as the computer (1102).

### EXAMPLES

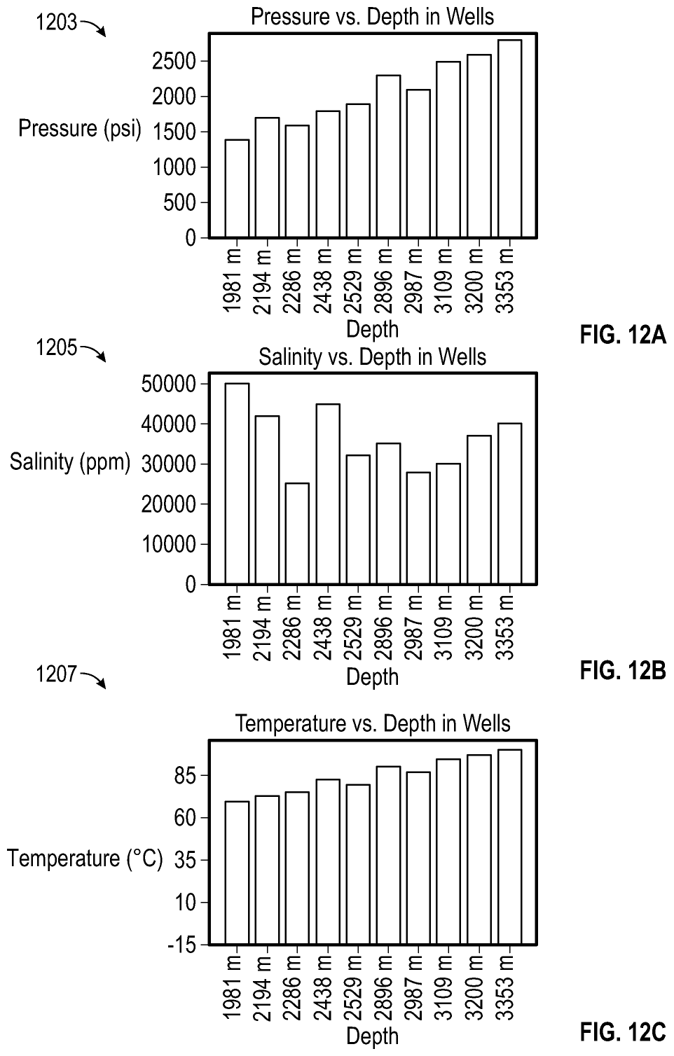

FIGS. 12A-12C depict synthetic example well data that may be used, for example, as the well data (305) in FIGS. 3 and 5. The example well data represented in FIGS. 12A-12C are the depth, pressure, salinity and temperature of 10 distinct synthetic wells. FIG. 12A depicts a bar plot (1203) of the pressure versus depth of example wells. In FIG. 12A, each bar represents a distinct well. The depth of each distinct well is shown in the abscissa axis, while the pressure of each distinct well is shown in the ordinate axis. FIG. 12B depicts a bar plot (1205) of the salinity versus depth of example wells. In FIG. 12B, each bar represents a distinct well. The depth of each distinct well is shown in the abscissa axis, while the salinity of each distinct well is shown in the ordinate axis. FIG. 12C depicts a bar plot (1207) of the temperature versus depth of example wells. In FIG. 12C, each bar represents a distinct well. The depth of each distinct well is shown in the abscissa axis, while the temperature of each distinct well is shown in the ordinate axis.

Table I depicts synthetic examples of well interventions performed on eight distinct synthetic well operations, as well as example reward components associated with each well intervention. The first column contains an identity (ID) of each of the eight well operations. The second column contains examples of well interventions. The third column contains a success rate (SR) for each well intervention, expressed as a percentage. The fourth column contains a cost efficiency (C_{eff}) for each well intervention. The fifth column contains a time efficiency (T_{eff}) for each well intervention. The sixth column contains an environmental impact score (EIS) for each well intervention. Each reward component in the fourth, fifth and sixth columns is a value between 1 and 3. A value of 1 stands for “low”. A value of 2 stands for “moderate” and a value of 3 stands for “high”. In some implementations, a reward for each well intervention in the second column applied to the well operation in the first column is computed based on the reward components in the third, fourth, fifth and sixth columns. In one or more embodiments, the reward is defined by as:

$$Reward = \frac{S R}{100} + {C}_{e f f} + {T}_{e f f} + ( 4 - EIS ) . \qquad EQ . 10$$

In one or more embodiments, the reward in EQ. 10 is used as the reward (611) in FIGS. 6 and 7.

TABLE I
Examples of well operations, well interventions
and corresponding reward components

| Well | Well | Success | Cost | Time | Environmental |
|---|---|---|---|---|---|
| operation ID | intervention | Rate (%) | Efficiency | Efficiency | Impact Score |
| S01 | Hydraulic | 87 | 3 | 2 | 1 |
| | Fracturing | | | | |
| S02 | Acidizing | 82 | 2 | 3 | 2 |
| S03 | Coil Tubing | 90 | 3 | 3 | 1 |
| | Insertion | | | | |
| S04 | Cementing | 78 | 1 | 1 | 3 |
| S05 | Fracturing | 85 | 2 | 2 | 2 |
| | Technique | | | | |
| S06 | Water | 80 | 3 | 1 | 2 |
| | Flooding | | | | |
| S07 | Gas Lift | 92 | 3 | 3 | 1 |
| S08 | Artificial Lift | 88 | 2 | 3 | 1 |

Table II depicts synthetic examples of well interventions performed on four distinct synthetic well operations, as well as examples of performances associated with each well operation and a performance optimization resulting from each well intervention. The first column contains an identity (ID) of each of the four well operations. The second column contains examples of well interventions. The third column contains examples of performances for each well operation from the first column. The fourth column contains a performance optimization obtained by conducting the well operation from the second column to the well operation from the first column.

TABLE 1
Examples of well operations, well interventions,
performances and performance optimization.

| Well | Well | | |
|---|---|---|---|
| operation ID | intervention | Performance | Performance optimization |
| S09 | Coil tubing | Hydrocarbon | Hydrocarbon production rate |
| | | production rate | increased by 20% |
| S10 | Fracturing | Sand production and | Reduced sand production, |
| | | hydrocarbon production | Hydrocarbon production rate |
| | | rate | increased by 5% |
| S11 | Acidizing | Hydrocarbon | Hydrocarbon production rate |
| | | production rate | increased by 2% |
| S12 | Perforation | Gas production rate | Gas production rate increased by 15% |

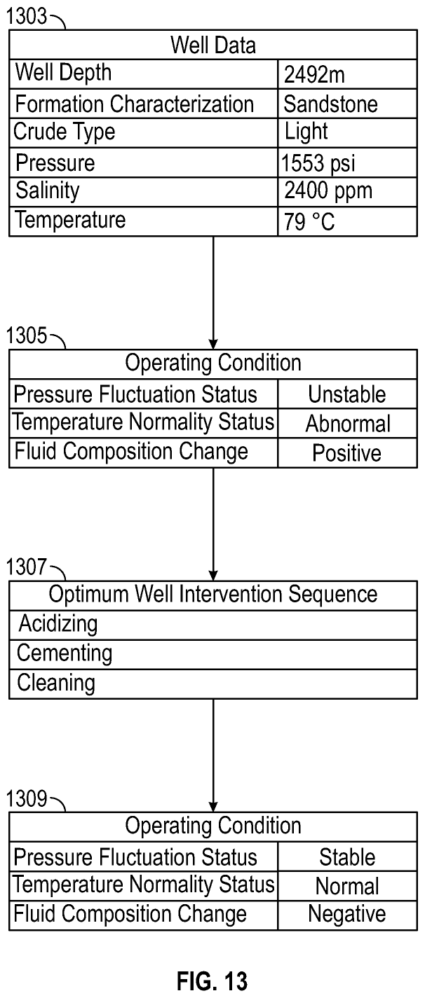

FIG. 13 depicts a synthetic example implementation of the method in FIG. 9. In FIG. 13, well data is defined, for a hydrocarbon production operation in a first tabular dataset (1303). The well data includes the well depth, a formation characterization, a crude type, the pressure, salinity and temperature of the well. The operating condition is defined as a set of three categorical variables: a pressure fluctuation status, a temperature normality status and a fluid composition change. The pressure fluctuation status is equal to “stable” is the pressure does not fluctuate, or “unstable” if the pressure fluctuates. The temperature normality status is equal to “normal” if the temperature is normal, or “abnormal” if the temperature is not normal. The fluid composition change is equal to “positive” if the fluid composition is changing, or “negative” if the fluid composition is not changing. The AI model, used in Step 905 in the method in FIG. 9 and in the systems in FIGS. 3 and 5 is a convolutional neural network, configured as a set of three binary classification models. The first binary classification model computes the pressure fluctuation status. The second binary classification model computes the temperature normality status. The third binary classification model computes the fluid composition change. The well data from the first tabular dataset (1303) is sent to the AI model. The AI model outputs an operating condition shown in a second tabular dataset (1305). An optimum well intervention sequence is determined by Steps 908-917 from the method in FIG. 9. The operating condition from the second tabular dataset (1305) is sent to the RL policy that returns, sequentially, an optimum well intervention sequence depicted in a third tabular dataset (1307). The optimum well intervention sequence depicted in a third tabular dataset (1307) modifies the operating condition from the second tabular dataset (1305) to the operating condition in a fourth tabular dataset (1309). The operating condition from the fourth tabular dataset (1309) is computed by a simulator, such as the simulator (571) in FIG. 5.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining a first well data for a well operation described by an operating condition;
determining, using an artificial intelligence (AI) model with the first well data as input, a first operating condition for the well operation;
obtaining a plurality of well interventions that can be performed on the well operation;
determining, using a reinforcement learning (RL) policy, an optimum well intervention sequence that optimizes a performance of the well operation; and
performing the optimum well intervention sequence on the well operation.

2. The method of claim 1, wherein determining the optimum well intervention sequence comprises:
initializing the optimum well intervention sequence as empty;
initializing an iterator n as n=1; and
iteratively, until stopped by a stopping criterion:
determining, using the RL policy with the n^{th} operating condition as input, a n^{th} optimum well intervention within the plurality of well interventions,
determining an (n+1)^{th} operating condition, using an environment that receives, as inputs, the n^{th} operating condition and the n^{th} optimum well intervention, wherein the environment comprises a simulator, and
appending the n^{th} optimum well intervention to the optimum well intervention sequence.

3. The method of claim 1, wherein the plurality of well interventions comprises one or more of:
hydraulic fracturing;
acidizing;
a perforation;
inserting coil tubing;
cementing;
water flooding;
a gas lift; and
an artificial lift.

4. The method of claim 1, wherein the AI model comprises a convolutional neural network (CNN) performing one or more of:
a classification;
a regression; and
an encoding.

5. The method of claim 1, wherein the RL policy comprises a neural network.

6. The method of claim 2, wherein the simulator comprises one or more of:
a solver for a fluid flow model;
a chemical formula;
a machine learning model; and
virtual reality hardware and software.

7. The method of claim 2:
wherein the RL policy is configured to receive, as input, an operating condition of the well operation and return, as output, a score for each well intervention within the plurality of well interventions, and
further comprising determining the RL policy using a reinforcement learning (RL) model, comprising:
initializing the RL policy;
obtaining a plurality of experience samples, each experience sample within the plurality of experience samples comprising:
an input operating condition,
an input well intervention within the plurality of well interventions,
an output operating condition obtained by inputting, to the environment, the input operating condition and the input well intervention, and
a reward based on the output well intervention; and
updating the RL policy using the plurality of experience samples.

8. The method of claim 7, wherein the RL model comprises one or more of:
a Q-learning model;
a deep Q-learning model; and
a policy gradient model.

9. The method of claim 7, wherein the reward for each experience sample is further based on one or more of:
the performance of the well operation;
a success rate of the input well intervention;
a cost efficiency of the input well intervention;
a time efficiency of the input well intervention; and
an environmental impact score of the input well intervention.

10. The method of claim 7,
further comprising:
performing a field well intervention on the well operation, the field well intervention being within the plurality of well interventions;
obtaining a second well data for the well operation after the field well intervention has been performed;
determining, using the AI model with the second well data as input, a feedback output operating condition for the well operation; and
including, in the plurality of experience samples, a field experience sample, wherein, for the field experience sample:
the input operating condition is the first operating condition,
the input operating condition is the field well intervention, and
the output operating condition is the feedback output operating condition; and
wherein the environment further comprises a feedback loop, configured to receive, as input, the first operating condition and the field well intervention and return, as output, the feedback output operating condition.

11. A system, comprising:
a well on which a well operation is performed, the well operation described by an operating condition;
a plurality of sensors connected to the well;
equipment to perform a plurality of well interventions on the well operation;
a simulator configured to simulate the well interventions within the plurality of well interventions;
a computer comprising one or more computer processors, configured to:
receive from, at least, the sensors, a first well data for the well operation,
determine, using an artificial intelligence (AI) model with the first well data as input, a first operating condition for the well operation,
determine, using a reinforcement learning (RL) policy, an optimum well intervention sequence that optimizes a performance of the well operation; and
a command system configured to send a command to perform the optimum well intervention sequence on the well operation.

12. The system of claim 11, wherein determining the optimum well intervention sequence comprises:
initializing the optimum well intervention sequence as empty;
initializing an iterator n as n=1; and
iteratively, until stopped by a stopping criterion:
determining, using the RL policy with the n^{th} operating condition as input, a n^{th} optimum well intervention within the plurality of well interventions,
determining an (n+1)^{th} operating condition, using an environment that receives, as inputs, the n^{th} operating condition and the n^{th} optimum well intervention, wherein the environment comprises the simulator, and
appending the n^{th} optimum well intervention to the optimum well intervention sequence.

13. The system of claim 11, wherein the plurality of well interventions comprises one or more of:
hydraulic fracturing;
acidizing;
a perforation;
inserting coil tubing;
cementing;
water flooding;
a gas lift; and
an artificial lift.

14. The system of claim 12, wherein the simulator comprises one or more of:
a solver for a fluid flow model;
a chemical formula;
a machine learning model; and
virtual reality hardware and software.

15. The system of claim 12, wherein:
the RL policy is configured to receive, as input, an operating condition of the well operation and return, as output, a score for each well intervention within the plurality of well interventions, and
the computer is further configured to determine the RL policy using a reinforcement learning (RL) model, comprising:
initializing the RL policy;
obtaining a plurality of experience samples, each experience sample within the plurality of experience samples comprising:
an input operating condition,
an input well intervention within the plurality of well interventions,
an output operating condition obtained by inputting, to the environment, the input operating condition and the input well intervention, and
a reward based on one or more of:
the output well intervention;
the performance of the well operation;
a success rate of the input well intervention;
a cost efficiency of the input well intervention;
a time efficiency of the input well intervention; and
an environmental impact score of the input well intervention; and
updating the RL policy using the plurality of experience samples.

16. The system of claim 15, wherein the RL model comprises one or more of:
a Q-learning model;
a deep Q-learning model; and
a policy gradient model.

17. The system of claim 15:
further comprising a command system configured to send a command to perform a field well intervention on the well operation, the field well intervention within the plurality of well interventions; and
wherein the computer is further configured to:
receive a second well data for the well operation after the field well intervention has been performed,
determine, using the AI model with the second well data as input, a feedback output operating condition for the well operation, and
include, in the plurality of experience samples, a field experience sample, wherein, for the field experience sample:
the input operating condition is the first operating condition;
the input operating condition is the field well intervention; and
the output operating condition is the feedback output operating condition; and
wherein the environment further comprises a feedback loop, configured to receive, as input, the first operating condition and the field well intervention and return, as output, the feedback output operating condition.

18. A non-transitory computer-readable memory comprising computer-executable instructions stored thereon that, when executed on a processor, cause the processor to perform steps comprising:
obtaining a first well data for a well operation described by an operating condition;
determining, using an artificial intelligence (AI) model with the first well data as input, a first operating condition for the well operation;
obtaining a plurality of well interventions that can be performed on the well operation;
determining, using a reinforcement learning (RL) policy, an optimum well intervention sequence that optimizes a performance of the well operation; and
sending a command to perform the optimum well intervention sequence on the well operation.

19. The non-transitory computer-readable memory of claim 18, wherein:
determining the optimum well intervention sequence comprises:
initializing the optimum well intervention sequence as empty;
initializing an iterator n as n=1; and
iteratively, until stopped by a stopping criterion:
determining, using the RL policy with the n^{th} operating condition as input, a n^{th} optimum well intervention within the plurality of well interventions,
determining an (n+1)^{th} operating condition, using an environment that receives, as inputs, the n^{th} operating condition and the n^{th} optimum well intervention, wherein the environment comprises a simulator, and
appending the n^{th} optimum well intervention to the optimum well intervention sequence; and
the plurality of well interventions comprises one or more of:
hydraulic fracturing,
acidizing,
a perforation,
inserting coil tubing,
cementing,
water flooding,
a gas lift, and
an artificial lift.

20. The non-transitory computer-readable memory of claim 19:
wherein the RL policy is configured to receive, as input, an operating condition of the well operation and return, as output, a score for each well intervention within the plurality of well interventions, and
the steps further comprise determining the RL policy using a reinforcement learning (RL) model, comprising:
initializing the RL policy;
obtaining a plurality of experience samples, each experience sample within the plurality of experience samples comprising:
an input operating condition,
an input well intervention within the plurality of well interventions,
an output operating condition obtained by inputting, to the environment, the input operating condition and the input well intervention, and
a reward based on one or more of:
the output well intervention;
the performance of the well operation;
a success rate of the input well intervention;
a cost efficiency of the input well intervention;
a time efficiency of the input well intervention; and
an environmental impact score of the input well intervention; and
updating the RL policy using the plurality of experience samples.
